(19) United States
(12) Patent Application Publication
(10) Pub. No.: US 2024/0292281 A1
(43) Pub. Date: Aug. 29, 2024

(54) METHOD FOR NSACF AND NSACF

(71) Applicant: NEC Corporation, Minato-ku, Tokyo (JP)

(72) Inventors: Iskren Ianev, Tokyo (JP); Toshiyuki Tamura, Tokyo (JP); Kundan Tiwari, Tokyo (JP)

(73) Assignee: NEC Corporation, Minato-ku, Tokyo (JP)

(21) Appl. No.: 18/572,819

(22) PCT Filed: Jun. 1, 2022
(86) PCT No.: PCT/JP2022/022373

§ 371 Date: Dec. 21, 2023

(30) Foreign Application Priority Data
Jun. 25, 2021 (IN) 202111028663

(51) Int. Cl. H04W 36/00; H04W 36/14

(52) U.S. Cl. CPC H04W 36/00222; H04W 36/144

(57) ABSTRACT

[Problem]

This disclosure solves a problem with the service continuity related to inter system change (e.g. EPS and 5GS intersystem change). This disclosure makes it possible to reduce the number of the interactions with the NSACF during the inter system change.

[Solution]

A method of an apparatus related to Session Management Function (SMF) includes sending, to an Access and Mobility Management Function (AMF) apparatus, a first message. The first message includes information indicating that the apparatus interacted with a Network Slice Admission Control Function (NSACF) apparatus for Network Slice Admission Control (NSAC). The method includes retaining a second message for the NSAC to be sent to the NSACF in a case where the first message includes the information.

### TECHNICAL FIELD

The present disclosure related to a method of an apparatus related to Session Management Function (SMF), a method of an Access and Mobility Management Function (AMF) apparatus, an apparatus related to SMF, and an AMF apparatus.

### BACKGROUND ART

Network slicing feature was defined in the 3GPP release 15 and release 16 specifications. GSMA 5GJA has introduced in NPL 5 the concept of Generic network Slice Template (GST) from which several Network Slice Types descriptions can be derived. Some of these parameters in the GST point explicitly to the definition of parameters and bounds on the service delivered to the end customer. For instance, the GST aims at the limitation of the number of PDU sessions per network slice, or the number of devices supported per network slice, or the maximum UL or DL data rate per network slice. The SA2 Rel-17 NPL 4 identified and addressed the gaps that needed to be filled in providing support for the GST parameters enforcement and the suitable solutions to address these gaps.

### CITATION LIST

### Non Patent Literature

[NPL 1] 3GPP TR 21.905: “Vocabulary for 3GPP Specifications”. V17.0.0 (2020-07)
[NPL 2] 3GPP TS 23.501: “System architecture for the 5G System (5GS)”. V17.0.0 (2021-03)
[NPL 3] 3GPP TS 23.502: “Procedures for the 5G System (5GS)”. V17.0.0 (2021-03)
[NPL 4] 3GPP TS 23.700-40: “Study on enhancement of network slicing”. V17.0.0 (2021-03)
[NPL 5] Generic Network Slice Template, https://www.gsma.com/newsroom/wp-content/uploads/NG.116-v2.0.pdf
[NPL 6] eNS_Ph2 exceptions sheet submitted to SAP #92E, ftp://ftp.3gpp.org/tsg_sa/TSG_SA/TSGs_92E_Electronic_2021_06/Docs/SP-210316.zip

### SUMMARY OF INVENTION

### Technical Problem

However, there are still outstanding issues related to RAT interworking and mobility (e.g. EPS and 5GS interworking and mobility). For example, according to the latest design in 3GPP, there is a problem that the NSACF (Network Slice Admission Control Function) is contacted at least twice during the EPS and 5GS inter system change.

### Solution to Problem

In an aspect of the present disclosure, a method of an apparatus related to Session Management Function (SMF) includes sending, to an Access and Mobility Management Function (AMF) apparatus, a first message. The first message includes information indicating that the apparatus interacted with a Network Slice Admission Control Function (NSACF) apparatus for Network Slice Admission Control (NSAC). The method includes retaining a second message for the NSAC to be sent to the NSACF in a case where the first message includes the information.

In an aspect of the present disclosure, a method of an apparatus related to Session Management Function (SMF) includes sending, to an Access and Mobility Management Function (AMF) apparatus, a first message. The method includes sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

In an aspect of the present disclosure, a method of an Access and Mobility Management Function (AMF) apparatus includes receiving, from an apparatus related to Session Management Function (SMF), a first message. The first message includes information indicating that the apparatus interacted with a Network Slice Admission Control Function (NSACF) apparatus for Network Slice Admission Control (NSAC). The method includes retaining a second message for the NSAC to be sent to the NSACF in a case where the first message includes the information.

In an aspect of the present disclosure, a method of an Access and Mobility Management Function (AMF) apparatus includes receiving, from an apparatus related to Session Management Function (SMF), a first message. The method includes sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

In an aspect of the present disclosure, a method of an apparatus related to Session Management Function (SMF) includes communicating with an Access and Mobility Management Function (AMF) apparatus. The method includes sending, to the AMF apparatus, a first message. The first message includes first information indicating that the apparatus is capable for a Network Slice Admission Control (NSAC) and second information indicating that the apparatus interacted with a Network Slice Admission Control Function (NSACF) apparatus for the NSAC.

In an aspect of the present disclosure, a method of an Access and Mobility Management Function (AMF) apparatus includes receiving, from an apparatus related to Session Management Function (SMF), a first message. The first message includes first information indicating that the apparatus is capable for a Network Slice Admission Control (NSAC) and second information indicating that the apparatus interacted with a Network Slice Admission Control Function (NSACF) apparatus for the NSAC. The method includes retaining a second message for the NSAC to be sent to the NSACF in a case where the first message includes the first information and the second information.

In an aspect of the present disclosure, a method of an Access and Mobility Management Function (AMF) apparatus includes receiving, from an apparatus related to Session Management Function (SMF), a first message. The method includes sending, to a Network Slice Admission Control Function (NSACF) apparatus, a second message for a Network Slice Admission Control (NSAC) in a case where the first message does not include first information indicating that the apparatus is capable for the NSAC and second information indicating that the apparatus interacted with the NSACF apparatus for the NSAC

In an aspect of the present disclosure, a method of an Access and Mobility Management Function (AMF) apparatus includes receiving, from an apparatus related to Session Management Function (SMF), a first message. The first message includes first information indicating that the apparatus is capable for a Network Slice Admission Control (NSAC) and second information indicating that the apparatus interacted with a Network Slice Admission Control Function (NSACF) apparatus for the NSAC. The method includes sending, to the apparatus, a second message. The second message includes the first information and the second information.

In an aspect of the present disclosure, a method of an apparatus related to Session Management Function (SMF) includes sending, to an Access and Mobility Management Function (AMF) apparatus, a first message. The first message includes first information indicating that the apparatus is capable for a Network Slice Admission Control (NSAC) and second information indicating that the apparatus interacted with a Network Slice Admission Control Function (NSACF) apparatus for the NSAC. The method includes retaining a second message for the NSAC to be sent to the NSACF in a case where the apparatus sends the first message to the AMF apparatus.

In an aspect of the present disclosure, a method of an apparatus related to Session Management Function (SMF) includes sending, to an Access and Mobility Management Function (AMF) apparatus, a first message. The method includes sending, to a Network Slice Admission Control Function (NSACF) apparatus, a second message for a Network Slice Admission Control (NSAC) in a case where the first message does not include first information indicating that a second apparatus related to SMF is capable for the NSAC and second information related to interaction between the second apparatus and the NSACF apparatus for the NSAC.

In an aspect of the present disclosure, an apparatus related to Session Management Function (SMF) includes means for sending, to an Access and Mobility Management Function (AMF) apparatus, a first message. The first message includes information indicating that the apparatus interacted with a Network Slice Admission Control Function (NSACF) apparatus for Network Slice Admission Control (NSAC). The apparatus includes means for retaining a second message for the NSAC to be sent to the NSACF in a case where the first message includes the information.

In an aspect of the present disclosure, an apparatus related to Session Management Function (SMF) includes means for sending, to an Access and Mobility Management Function (AMF) apparatus, a first message. The apparatus includes means for sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

In an aspect of the present disclosure, an Access and Mobility Management Function (AMF) apparatus includes means for receiving, from an apparatus related to Session Management Function (SMF), a first message. The first message includes information indicating that the apparatus interacted with a Network Slice Admission Control Function (NSACF) apparatus for Network Slice Admission Control (NSAC). The AMF apparatus includes means for retaining a second message for the NSAC to be sent to the NSACF in a case where the first message includes the information.

In an aspect of the present disclosure, an Access and Mobility Management Function (AMF) apparatus includes means for receiving, from an apparatus related to Session Management Function (SMF), a first message. The AMF apparatus includes means for sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

In an aspect of the present disclosure, an apparatus related to Session Management Function (SMF) includes means for communicating with an Access and Mobility Management Function (AMF) apparatus. The apparatus includes means for sending, to the AMF apparatus, a first message. The first message includes first information indicating that the apparatus is capable for a Network Slice Admission Control (NSAC) and second information indicating that the apparatus interacted with a Network Slice Admission Control Function (NSACF) apparatus for the NSAC.

In an aspect of the present disclosure, an Access and Mobility Management Function (AMF) apparatus includes means for receiving, from an apparatus related to Session Management Function (SMF), a first message. The first message includes first information indicating that the apparatus is capable for a Network Slice Admission Control (NSAC) and second information indicating that the apparatus interacted with a Network Slice Admission Control Function (NSACF) apparatus for the NSAC. The AMD apparatus includes means for retaining a second message for the NSAC to be sent to the NSACF in a case where the first message includes the first information and the second information.

In an aspect of the present disclosure, an Access and Mobility Management Function (AMF) apparatus includes means for receiving, from an apparatus related to Session Management Function (SMF), a first message. The AMD apparatus includes means for sending, to a Network Slice Admission Control Function (NSACF) apparatus, a second message for a Network Slice Admission Control (NSAC) in a case where the first message does not include first information indicating that the apparatus is capable for the NSAC and second information indicating that the apparatus interacted with the NSACF apparatus for the NSAC.

In an aspect of the present disclosure, an Access and Mobility Management Function (AMF) apparatus includes means for receiving, from an apparatus related to Session Management Function (SMF), a first message. The first message includes first information indicating that the apparatus is capable for a Network Slice Admission Control (NSAC) and second information indicating that the apparatus interacted with a Network Slice Admission Control Function (NSACF) apparatus for the NSAC. The AMF apparatus includes means for sending, to the apparatus, a second message. The second message includes the first information and the second information.

In an aspect of the present disclosure, an apparatus related to Session Management Function (SMF) includes means for sending, to an Access and Mobility Management Function (AMF) apparatus, a first message. The first message includes first information indicating that the apparatus is capable for a Network Slice Admission Control (NSAC) and second information indicating that the apparatus interacted with a Network Slice Admission Control Function (NSACF) apparatus for the NSAC. The apparatus includes means for retaining a second message for the NSAC to be sent to the NSACF in a case where the apparatus sends the first message to the AMF apparatus.

In an aspect of the present disclosure, an apparatus related to Session Management Function (SMF) includes means for sending, to an Access and Mobility Management Function (AMF) apparatus, a first message. The apparatus includes means for sending, to a Network Slice Admission Control Function (NSACF) apparatus, a second message for a Network Slice Admission Control (NSAC) in a case where the first message does not include first information indicating that a second apparatus related to SMF is capable for the NSAC and second information related to interaction between the second apparatus and the NSACF apparatus for the NSAC.

In an aspect of the present disclosure, a method of a first apparatus includes communicating with a second apparatus. The method includes receiving, from the second apparatus, a first parameter related to Network Slice Admission Control (NSAC) status. The second apparatus sends, to a third apparatus, a second parameter to increment the number of Protocol Data Unit (PDU) session(s) based on the first parameter.

In an aspect of the present disclosure, a method of a second apparatus includes sending, to a first apparatus, a first parameter related to Network Slice Admission Control (NSAC) status. The method includes increasing number of the communication apparatus being registered for a network slice parameter in a case where the first parameter does not include information indicating that the a second apparatus communicate with a third apparatus regarding the number of the communication apparatus.

In an aspect of the present disclosure, a method of a first apparatus includes receiving, from a second apparatus, a third parameter related to Network Slice Admission Control (NSAC) status. The method includes sending, to the second apparatus, a message to decrement number of Protocol Date Unite (PDU) session (s) based on the third parameter.

In an aspect of the present disclosure, a method of a first apparatus includes receiving, from a second apparatus, a third parameter related to Network Slice Admission Control (NSAC) status. The method includes sending, to a third apparatus, a fourth parameter to decrement number of communication apparatus being registered for a network slice parameter based on the third parameter.

### BRIEF DESCRIPTION OF DRAWINGS

FIG. 1 illustrates Service continuity use cases.

FIG. 2 illustrates Efficient Network Slice Admission Control in EPS to 5GS handover in Aspect 1.

FIG. 3 illustrates Efficient Network Slice Admission Control in 5GS to EPS handover in Aspect 2.

FIG. 4 illustrates System overview.

FIG. 5 is a block diagram for a User equipment (UE).

FIG. 6 is a block diagram for a (R)AN node.

FIG. 7 illustrates System overview of (R)AN node 5 based on O-RAN architecture.

FIG. 8 is a block diagram for a Radio Unit (RU).

FIG. 9 is a block diagram for a Distributed Unit (DU).

FIG. 10 is a block diagram for a Centralized Unit (CU).

FIG. 11 is a block diagram for an AMF.

FIG. 12 is a block diagram for an SMF.

FIG. 13 is a block diagram for a UDM.

FIG. 14 is a block diagram for a NSACF.

FIG. 15 illustrates 5GS to EPS handover for single-registration mode with N26 interface.

FIG. 16 illustrates EPS to 5GS handover using N26 interface, execution phase.

### DESCRIPTION OF EMBODIMENTS

This disclosure and Aspects relate to a method of an apparatus related to Session Management Function (SMF), a method of an Access and Mobility Management Function (AMF) apparatus, an apparatus related to SMF, and an AMF apparatus and so on.

Each of aspects and elements included in the each aspects described below may be implemented independently or in combination with any other. These aspects include novel characteristics different from one another. Accordingly, these aspects contribute to achieving objects or solving problems different from one another and contribute to obtaining advantages different from one another.

The 3GPP SA2 Working Group will continue addressing open issues within the Rel-17 standardization work as planned in NPL 6.

One of the outstanding problems is how to control the number of UEs registered with a network slice and the number of the PDU Sessions established on a network slice in the case of EPS and 5GS interworking and mobility. In NPL 6 the SA2 noted its intention to ‘finalize the support for EPC interworking’ during the 3GPP Rel-17 standardization work.

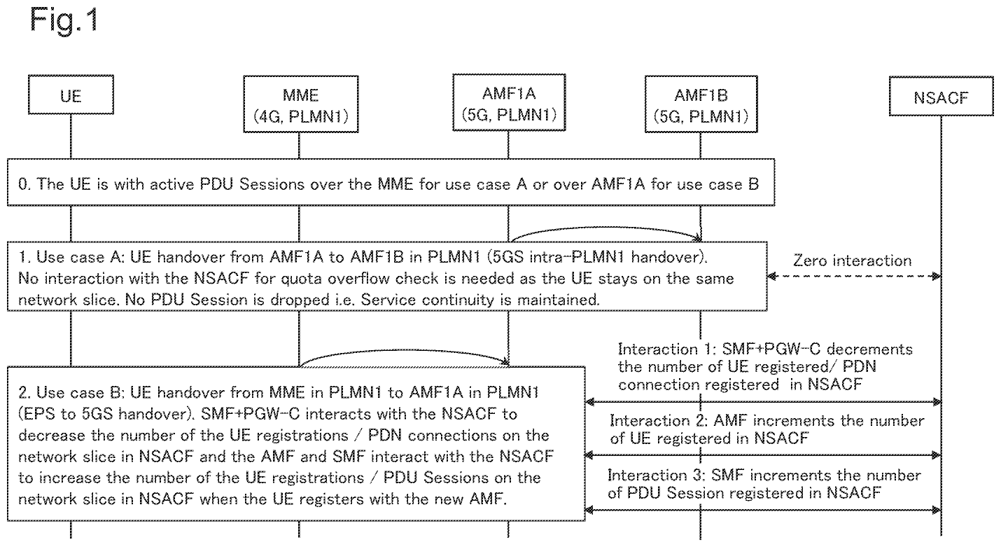

FIG. 1 below demonstrates the difference between the UE mobility within the 5GS and the UE mobility between the EPS and 5GS in terms of the numbers of the UEs registrations per network slice and the numbers of the PDU Sessions on a network slice controlled by the NSACF.

0. At starting point the UE is in connected mode either with a PDN connection in EPS or with an active PDU Session in 5GS.

1. Use case A: UE handover within 5GS (e.g. from AMF1A to AMF1B in PLMN1, i.e. 5GS intra PLMN1 handover). No interaction with the NSACF (Network Slice Admission Control Function) for the number of UEs per network slice or number of PDU Sessions per network slice is needed if the UE stays on the same network slice. In this case the UE stays registered with the network slice on which it was before the handover and the UE maintains the PDU Session active after the handover regardless whether the number of the registered UEs or the number of established PDU Sessions on the network slice has reached its maximum or not. No PDU Session is dropped i.e. the service continuity in the 5GS internal mobility is maintained.

2. Use case B: UE handover from EPS (MME) to 5GS (AMF1A). If the NSAC (Network Slice Admission Control) i.e. the number of UEs per network slice control or the number of PDU Sessions per network slice control is supported in the EPS (i.e. 4G), which is a valid deployment option, at EPS to 5GS intersystem change (e.g. handover from EPS to 5GS), the SMF+PGW-C interacts with the NSACF to decrease at least one of the number of UEs per network slice and the number of PDU Sessions per network slice. When the UE is registered in the new AMF, the new AMF interacts with the NSACF to increase at least one of the number of UEs per network slice and the number of PDU Sessions per network slice control.

It is obvious that the Use case B incurs too much signaling to the NSACF compared to the Use case A and this may cause signaling congestion due to Network Slice Admission Control and may influence the overall system performance in both, in the EPS and in the 5GS.

### <Abbreviations>

For the purposes of the present document, the abbreviations given in NPL 1 and the following apply. An abbreviation defined in the present document takes precedence over the definition of the same abbreviation, if any, in NPL 1.
3GPP 3rd Generation Partnership Project
4G-GUTI 4G Globally Unique Temporary UE Identity
5G 5th Generation
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AS Access Stratum
ATSSS Access Traffic Steering, Switching, Splitting
ATSSS-LL ATSSS Low-Layer
AUSF Authentication Server Function
AUTN Authentication token
BMCA Best Master Clock Algorithm
BSF Binding Support Function
CAG Closed Access Group
CAPIF Common API Framework for 3GPP northbound
APIs
CHF Charging Function
CN PDB Core Network Packet Delay Budget
CP Control Plane
DAPS Dual Active Protocol Stacks
DCN Dedicated Core Network
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GSMA Global System for Mobile Communications
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
LTE Long Term Evolution
MCC Mobile country code
MCX Mission Critical Service
MDBV Maximum Data Burst Volume
MFBR Maximum Flow Bit Rate
MICO Mobile Initiated Connection Only
MITM Man In The Middle
MNC Mobile Network Code
MPS Multimedia Priority Service
MPTCP Multi-Path TCP Protocol
N3IWF Non-3GPP Inter Working Function
N5CW Non-5G-Capable over WLAN
NAI Network Access Identifier
NAS Non-Access Stratum
NEF Network Exposure Function
NF Network Function
NGAP Next Generation Application Protocol
NG-RAN Next Generation Radio Access Network
NID Network identifier
NPN Non-Public Network
NR New Radio
NRF Network Repository Function
NSAC Network Slice Admission Control
NSACF Network Slice Admission Control Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDN Packet Data Network
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited PLMN
V-SMF Visited SMF
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

The principle of below Aspects is also applicable for the idle mode mobility procedure between 5GS and EPS.

<Aspect 1: Efficient Network Slice Admission Control in EPS to 5GS Handover>

The Aspect 1 is a solution for the service continuity problem described in Use Case B in FIG. 1 where the UE has an active PDN connection(s) at EPS to 5GS handover.

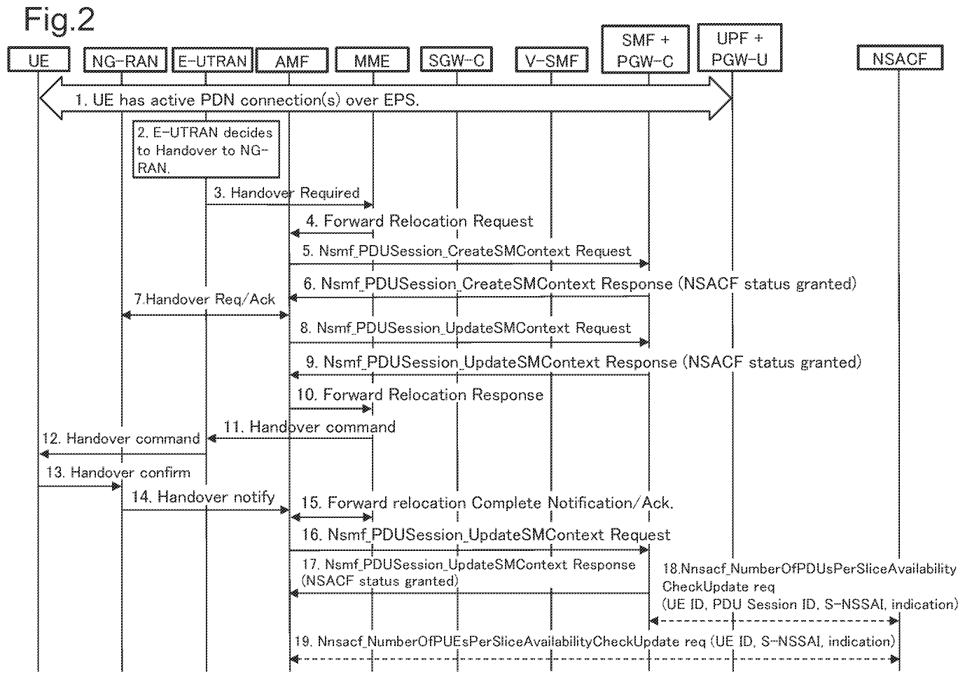

This solution, demonstrated in FIG. 2, allows the Network Slice Admission Control with the minimum number of interactions with the NSACF.
1. The UE is in connected mode with active PDN connection(s) over the MME in EPS (i.e. 4G).
2. The E-UTRAN decides to handover to the NG-RAN.
3. The E-UTRAN sends the Handover Required message to the MME.
4. The MME sends the Forward Relocation Request message to the AMF.
5. The AMF sends, to the SMF+PGW-C, Nsmf_PDUSession_CreateSMContext Request message including an SM Context ID.
6. Upon reception of the Nsmf_PDUSession_CreateSMContext Request message, the SMF+PGW-C sends Nsmf_PDUSession_CreateSMContext Response message to the AMF.

The SMF+PGW-C may include, in the Nsmf_PDUSession_CreateSMContext Response message, ‘NSACF status granted’ parameter or any other notation for a parameter, for example NSAC counting indicator, to indicate that the Network Slice Admission Control (NSAC), i.e. quota control is supported in the EPS and the EPS had already granted the NSAC status, i.e. the EPS (e.g. SMF+PGW-C) had already interacted with the NSACF regarding at least one of the number of UE registrations control and the number of the PDN connections and the NSACF had granted an admission. The ‘NSACF status granted’ parameter may be called as information related to interaction between the SMF+PGW-C and the NSACF for the NSAC.

For example, once the SMF+PGW-C interacts with the NSACF, the SMF+PGW-C includes the ‘NSACF status granted’ parameter in the Nsmf_PDUSession_CreateSMContext Response message. For example, the SMF+PGW-C may interact with the NSACF for the NSAC before step 6 or before sending the Nsmf_PDUSession_CreateSMContext Response message in step 6.

The ‘NSACF status granted’ parameter may be split into two parts or two separate parameters, one for Network Slice Admission Control for the UE registration with the S-NSSAI and the other one for Network Slice Admission Control for the PDN connection or PDU Session established on the S-NSSAI. The SMF+PGW-C may include multiple ‘NSACF status granted’ parameters for PDU Session(s) per S-NSSAI if the SMF+PGW-C manages multiple PDU Session(s).

If the ‘NSACF status granted’ parameter is not included in the Nsmf_PDUSession_CreateSMContext Response message, it means that either the EPS does not support NSAC or the EPS had not granted NSAC. I.e. it means that at least one of the UE registration and the PDN connections had not been registered with the NSACF for the purpose of at least one of maximum registered UEs on a network slice control and maximum number of PDU Sessions established on a network slice control.

7. The AMF sends the Handover Request message to the NG-RAN to reserve resources in the NG-RAN and the NG-RAN replies to the AMF by sending the Handover Request Acknowledge message.

8. The AMF sends Nsmf_PDUSession_UpdateSMContext Request message to the SMF+PGW-C for updating N3 tunnel information.

9. Upon reception of the Nsmf_PDUSession_UpdateSMContext Request message, the SMF+PGW-C sends Nsmf_PDUSession_UpdateSMContext Response message to the AMF. The SMF+PGW-C may include the ‘NSACF status granted’ parameter in the Nsmf_PDUSession_UpdateSMContext Response message if the SMF+PGW-C has not yet provided this parameter to the AMF during the EPS to 5GS handover procedure.

For example, the SMF+PGW-C may include the ‘NSACF status granted’ parameter in the Nsmf_PDUSession_UpdateSMContext Response message in step 9 in a case where the SMF+PGW-C does not include the ‘NSACF status granted’ parameter in the Nsmf_PDUSession_CreateSMContext Response message in step 6. For example, the SMF+PGW-C may interact with the NSACF for the NSAC before step 9 or before sending the Nsmf_PDUSession_UpdateSMContext Response message in step 9.

10. The AMF sends the Forward Relocation Response message to the MME.

11. The MME sends the Handover command message to the E-UTRAN.

12. The E-UTRAN sends the Handover command message to the UE.

13. Upon reception of the Handover command message, the UE sends the Handover confirm message to the NG-RAN.

14. The NG-RAN sends the Handover notify message to the AMF.

15. The AMF sends the Forward relocation Complete Notification message to the MME to inform that the UE has successfully handed over the 5GS. Then the MME sends the Forward relocation Complete Notification Acknowledge message to the AMF.

16. The AMF sends Nsmf_PDUSession_UpdateSMContext Request message to the SMF+PGW-C for notifying the completion of the handover.

17. Upon reception of the Nsmf_PDUSession_UpdateSMContext Request message, the SMF+PGW-C sends Nsmf_PDUSession_UpdateSMContext Response message to the AMF. The SMF+PGW-C may include the ‘NSACF status granted’ parameter in the Nsmf_PDUSession_UpdateSMContext Response message if the SMF+PGW-C has not yet provided this parameter to the AMF during the EPS to 5GS handover procedure. For example, the SMF+PGW-C may include the ‘NSACF status granted’ parameter in the Nsmf_PDUSession_UpdateSMContext Response message in step 17 in a case where the SMF+PGW-C does not include the ‘NSACF status granted’ parameter in the Nsmf_PDUSession_CreateSMContext Response message in step 6 and the SMF+PGW-C does not include the ‘NSACF status granted’ parameter in the Nsmf_PDUSession_UpdateSMContext Response message in step 9. For example, the SMF+PGW-C may interact with the NSACF for the NSAC before step 17 or before sending the Nsmf_PDUSession_UpdateSMContext Response message in step 17.

18. Upon reception of the Nsmf_PDUSession_UpdateSMContext Request message with Handover Complete Indication for PDU Session ID or after sending the Nsmf_PDUSession_UpdateSMContext Response message in step 17, the SMF+PGW-C may decide whether to send the Nnsacf_NumberOfPDUsPerSliceAvailabilityCheckUpdate req to the NSACF to increment the number of PDU Sessions being established for the S-NSSAI. For example, the increment process is one of the NSAC processes.

For example, if the SMF-PGW-C includes the ‘NSACF status granted’ parameter in at least one of the Nsmf_PDUSession_CreateSMContext Response message in step 6 and the Nsmf_PDUSession_UpdateSMContext Response message in step 9 and the Nsmf_PDUSession_UpdateSMContext Response message in step 17, the SMF+PGW-C does not send the Nnsacf_NumberOfPDUsPerSliceAvailabilityCheckUpdate req to the NSACF.

I.e., the SMF+PGW-C does not send the Nnsacf_NumberOfPDUsPerSliceAvailabilityCheckUpdate req to the NSACF if the SMF+PGW-C had already interacted with the NSACF to increment the numbers of PDU Sessions being established for the S-NSSAI while the UE was in the EPS or alternatively if the SMF+PGW-C has included the ‘NSACF status granted’ parameter in at least one of messages in step 6, 9 and 17.

Note that if the SMF+PGW-C does not include the ‘NSACF status granted’ parameter in the Nsmf_PDUSession_CreateSMContext Response message in step 6 and the Nsmf_PDUSession_UpdateSMContext Response message in step 9 and the Nsmf_PDUSession_UpdateSMContext Response message in step 17, the SMF+PGW-C may send the Nnsacf_NumberOfPDUsPerSliceAvailabilityCheckUpdate req to the NSACF to increment the number of PDU Sessions being established for the S-NSSAI.

I.e. the SMF+PGW-C may send the Nnsacf_NumberOfPDUsPerSliceAvailabilityCheckUpdate req to the NSACF if the SMF+PGW-C has not yet interacted with the NSACF to increment the numbers of PDU Sessions being established for the S-NSSAI while the UE was in the EPS or alternatively if the SMF+PGW-C does not include the ‘NSACF status granted’ parameter in all messages in step 6, 9 and 17.

The Nnsacf_NumberOfPDUsPerSliceAvailabilityCheckUpdate req includes UE ID (or identifier of the UE), PDU Session ID (or identifier of the PDU Session), and S-NSSAI.

The SMF+PGW-C may include an indication parameter to the Nnsacf_NumberOfPDUsPerSliceAvailabilityCheckUpdate req. The indication parameter indicates that this increment request is due to handover to the 5GS.

One example, the SMF+PGW-C sends the Nnsacf_NumberOfPDUsPerSliceAvailabilityCheckUpdate req to the NSACF based on a local configuration in the SMF+PGW-C.

One another example, the SMF+PGW-C sends the Nnsacf_NumberOfPDUsPerSliceAvailabilityCheckUpdate req to the NSACF during the EPS to 5GS Mobility Registration Procedure that takes place after the step 17.

Yet in one more example, the SMF+PGW-C may send the Nnsacf_NumberOfUEsPerSliceAvailabilityCheckUpdate req to the NSACF to increment the number of the UEs being registered for the S-NSSAI.

19. Based on the received ‘NSACF status granted’ parameter in either step 6 or 9 or 17, the AMF may decide whether to send the Nnsacf_NumberOfUEsPerSliceAvailabilityCheckUpdate req to the NSACF to increment the number of the UEs being registered for the S-NSSAI.

For example, if the received ‘NSACF status granted’ parameter indicates that the SMF+PGW-C had interacted with the NSACF to increment the number of the UEs being registered for the S-NSSAI while the UE was in the EPS or alternatively if the ‘NSACF status granted’ parameter has been included in at least one of messages in steps 6, 9 and 17, the AMF does not send the Nnsacf_NumberOfUEsPerSliceAvailabilityCheckUpdate req to the NSACF.

Note that, if the received ‘NSACF status granted’ parameter indicates that the SMF+PGW-C has not yet interacted with the NSACF to increment the number of the UEs being registered for the S-NSSAI while the UE was in the EPS or alternatively if the ‘NSACF status granted’ parameter was not included in all messages in steps 6, 9 and 17, the AMF may send the Nnsacf_NumberOfUEsPerSliceAvailabilityCheckUpdate req to the NSACF.

The Nnsacf_NumberOfUEsPerSliceAvailabilityCheckUpdate req includes UE ID, and S-NSSAI.

The AMF may include an indication parameter to the Nnsacf_NumberOfUEsPerSliceAvailabilityCheckUpdate request message. The indication parameter indicates that this increment request is due to handover to the 5GS.

One example, the AMF sends the Nnsacf_NumberOfUEsPerSliceAvailabilityCheckUpdate req to the NSACF during the EPS to 5GS Mobility Registration Procedure that takes place after the step 17.

### <Aspect 2: Efficient Network Slice Admission Control in 5GS to EPS Handover>

The Aspect 2 is a solution for the service continuity problem described in Use Case B in FIG. 1. This solution solves the problem where the UE has an active PDU Session(s) at 5GS to EPS handover.

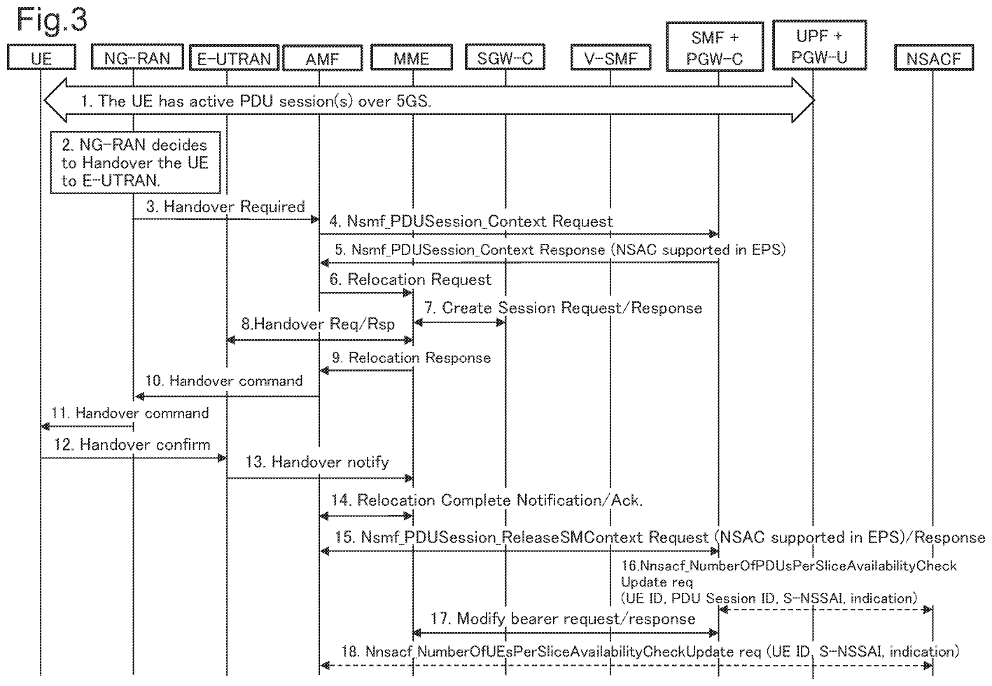

This solution, demonstrated in FIG. 3, allows the Network Slice Admission Control with the minimum number of interactions with the NSACF.
1. The UE is in connected mode with active PDU Session(s) over the AMF in 5GS (i.e. 5G).
2. The NG-RAN decides to handover to the E-UTRAN.
3. The NG-RAN sends the Handover Required message to the the AMF.
4. The AMF sends the Nsmf_PDUSession_Context Request message to the SMF+PGW-C.

For example, the Nsmf_PDUSession_Context Request message includes an SM Context ID.

5. Upon reception of the Nsmf_PDUSession_Context Request message, the SMF+PGW-C sends, to the AMF, Nsmf_PDUSession_Context Response message including an ‘NSAC supported in EPS’ parameter.

The ‘NSAC supported in EPS’ parameter may be set to “supported” status or “not supported” status. The ‘NSAC supported in EPS’ parameter set to “supported” status indicates that the SMF+PGW-C is capable for Network Slice Admission Control in EPS and had already enforced (or performed) the Network Slice Admission Control in EPS for the S-NSSAI associated with the received SM Context ID.

The ‘NSAC supported in EPS’ parameter set to “not supported” status indicates that the SMF+PGW-C is not capable for Network Slice Admission Control in EPS or had not yet enforced (or not yet performed) the Network Slice Admission Control in EPS for the S-NSSAI associated with the received SM Context ID. For example, the SMF+PGW-C may interact with the NSACF for the NSAC before step 5 or before sending the Nsmf_PDUSession_Context Response message in step 5.

The ‘NSAC supported in EPS’ parameter may be split into two parts, one for Network Slice Admission Control for the UE registration to the S-NSSAI and the other one for Network Slice Admission Control for the PDN connection or PDU Session established on the S-NSSAI.

The SMF+PGW-C may include multiple ‘NSAC supported in EPS’ parameters for PDU Session(s) per S-NSSAI if the SMF+PGW-C manages multiple PDU Session(s).

Note that some ‘NSAC supported in EPS’ parameter(s) for PDU Session(s) may indicate “supported” status, while some other ‘NSAC supported in EPS’ parameter(s) for PDU Session(s) may indicate “not supported” since the Network Slice Admission Control can be activated per S-NSSAI basis.

In addition, lack of the ‘NSAC supported in EPS’ parameter in the Nsmf_PDUSession_Context Response message is interpreted as “not supported” by the AMF. This typically happens if the SMF+PGW-C is made based on the Release 16 and earlier version of the 3GPP standards.

6. The AMF sends the Relocation Request to the MME.

7. The MME sends the Create Session Request message to the SGW-C to set up resources in the EPC and the SGW-C replies to the MME by sending the Create Session Response message.

8. The MME sends the Handover Request message to the E-UTRAN to reserve resources in the E-UTRAN and the E-UTRAN replies to the MME by sending the Handover Response message.

9. The MME sends the Relocation Response message to the AMF.

10. The AMF sends the Handover command message to the NG-RAN.

11. The NG-RAN sends the Handover command message to the UE.

12. Upon reception of the Handover command message, the UE sends the Handover confirm message to the E-UTRAN.

13. The E-UTRAN sends the Handover notify message to the MME.

14. The MME sends the Relocation Complete Notification to the AMF to inform that the UE has successfully handed over the EPS. Then the AMF sends the Relocation Complete Notification Acknowledge message to the MME.

15. The AMF sends the Nsmf_PDUSession_ReleaseSMContext Request message to the SMF+PGW-C via the V-SMF to request deleting the resources in the 5GS. This message may include the ‘NSAC supported in EPS’ parameter. This parameter is constructed based on the received ‘NSAC supported in EPS’ parameter in step 5.

For example, if the received ‘NSAC supported in EPS’ parameter in step 5 is set to “supported” status, the AMF sends, to the SMF+PGW-C, the Nsmf_PDUSession_ReleaseSMContext Request message including the ‘NSAC supported in EPS’ parameter set to “supported” status.

For example, if the received ‘NSAC supported in EPS’ parameter in step 5 is set to “not supported” status, the AMF sends, to the SMF+PGW-C, the Nsmf_PDUSession_ReleaseSMContext Request message including the ‘NSAC supported in EPS’ parameter set to “not supported” status.

The SMF+PGW-C sends the Nsmf_PDUSession_ReleaseSMContext Response message to the AMF.

16. Upon reception of the Nsmf_PDUSession_ReleaseSMContext Request message, the SMF+PGW-C may decide whether to send the Nnsacf_NumberOfPDUsPerSliceAvailabilityCheckUpdate req to the NSACF to decrement the number of PDU Sessions being established for the S-NSSAI.

If the ‘NSAC supported in EPS’ parameter received in step 15 indicates “supported” status, the SMF+PGW-C does not send the Nnsacf_NumberOfPDUsPerSliceAvailabilityCheckUpdate req to the NSACF.

If the ‘NSAC supported in EPS’ parameter received in step 15 indicates “not supported” status, the SMF+PGW-C may send the Nnsacf_NumberOfPDUsPerSliceAvailabilityCheckUpdate req to the NSACF.

The Nnsacf_NumberOfPDUsPerSliceAvailabilityCheckUpdate req includes UE ID, PDU Session ID, and S-NSSAI.

The SMF+PGW-C may include an indication parameter to the Nnsacf_NumberOfPDUsPerSliceAvailabilityCheckUpdate req. The indication parameter indicates that this decrement request is due to handover to the EPS.

One example, the SMF+PGW-C sends the Nnsacf_NumberOfPDUsPerSliceAvailabilityCheckUpdate req to the NSACF based on a local configuration in the SMF+PGW-C.

One another example, the SMF+PGW-C sends the Nnsacf_NumberOfPDUsPerSliceAvailabilityCheckUpdate req to the NSACF during the 5GS to EPS Mobility Registration Procedure that takes place after the step 15.

In one example, if the SMF+PGW-C sends, to the AMF, the Nsmf_PDUSession_Context Response message including the ‘NSAC supported in EPS’ parameter which is set to “supported” status in step 5, the SMF+PGW-C does not send the Nnsacf_NumberOfPDUsPerSliceAvailabilityCheckUpdate req to the NSACF.

In one example, if the SMF+PGW-C sends, to the AMF, the Nsmf_PDUSession_Context Response message including the ‘NSAC supported in EPS’ parameter which is set to “not supported” status in step 5, the SMF+PGW-C may send the Nnsacf_NumberOfPDUsPerSliceAvailabilityCheckUpdate req to the NSACF.

In one example, if the SMF+PGW-C sends, to the AMF, the Nsmf_PDUSession_Context Response message which does not include the ‘NSAC supported in EPS’ parameter in step 5, the SMF+PGW-C may send the Nnsacf_NumberOfPDUsPerSliceAvailabilityCheckUpdate req to the NSACF.

17. The MME sends the Modify bearer request message to the SMF+PGW-C for updating S1-U tunnel information and the SMF+PGW-C replies to the MME by sending the Modify bearer response message.

18. Based on the received ‘NSAC supported in EPS’ parameter in step 5, the AMF may decide whether to send the Nnsacf_NumberOfUEsPerSliceAvailabilityCheckUpdate req to the NSACF to decrement the number of UEs being registered for the S-NSSAI.

If the ‘NSAC supported in EPS’ parameter received in step 5 indicates “supported” status, the AMF does not send the Nnsacf_NumberOfUEsPerSliceAvailabilityCheckUpdate req to the NSACF.

If the ‘NSAC supported in EPS’ parameter received in step 5 indicates “not supported” status, the AMF may send the Nnsacf_NumberOfUEsPerSliceAvailabilityCheckUpdate req to the NSACF.

The Nnsacf_NumberOfUEsPerSliceAvailabilityCheckUpdate req includes UE ID, and S-NSSAI.

The AMF may include an indication parameter to the Nnsacf_NumberOfUEsPerSliceAvailabilityCheckUpdate request message. The indication parameter indicates that this decrement request is due to handover to the EPS.

One example, the AMF sends the Nnsacf_NumberOfUEsPerSliceAvailabilityCheckUpdate req to the NSACF during the 5GS to EPS Mobility Registration Procedure that takes place after the step 15.

This disclosure and the Aspects can solve a problem with the service continuity between EPS and 5GS inter system change. For example, this disclosure and the Aspects make it possible to reduce the number of the interactions with the NSACF during the EPS and 5GS inter system change. In addition, for example, this disclosure and the Aspects can provide efficient system design even if the EPS and 5GS inter system change often happens especially when the 5GS is being introduced on top of the EPS coverage.

### <System Overview>

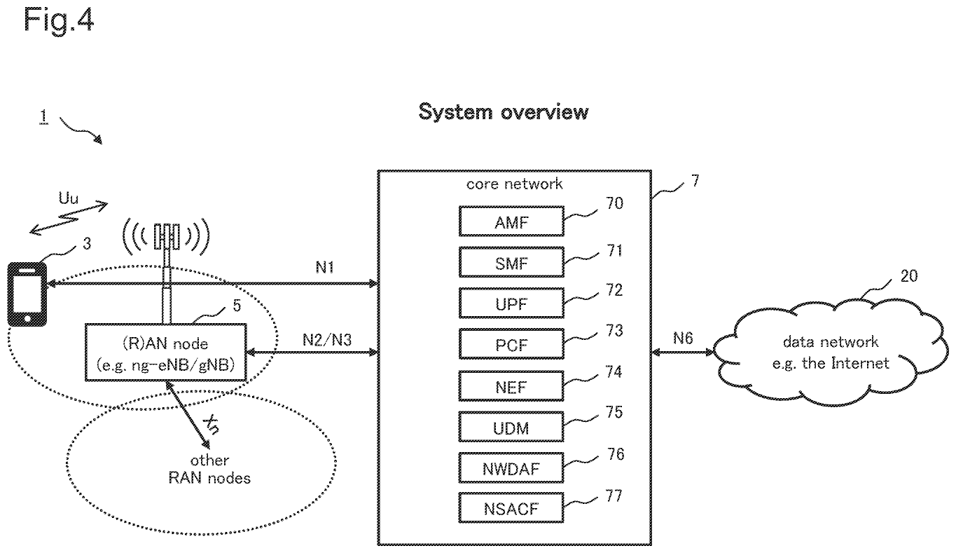

FIG. 4 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, a Network Data Analytics Function (NWDAF) 76 and NSACF (Network Slice Admission Control Function) 77. In addition, the core network 7 may also include SMF+PGW-C, and V-SMF.

When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC Setup Complete message: This message is sent from the UE 3 to the (R)AN node 5. In addition to the parameters that are disclosed by Aspects in this disclosure, following parameters may be included together in the RRC Setup Complete message.
   guami-Type, iab-Nodelndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by Aspects in this disclosure, following parameters may be included together in the Registration Request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by Aspects in this disclosure, following parameters may be included together in the Registration Accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### <User Equipment (UE)>

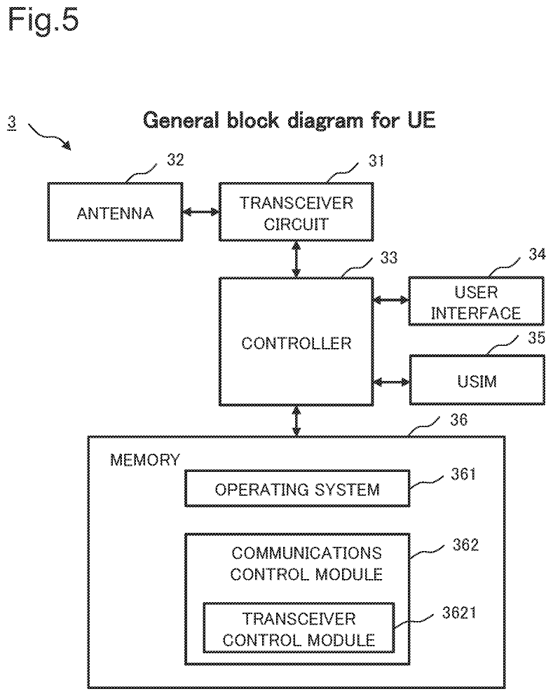

FIG. 5 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

the UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

the UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

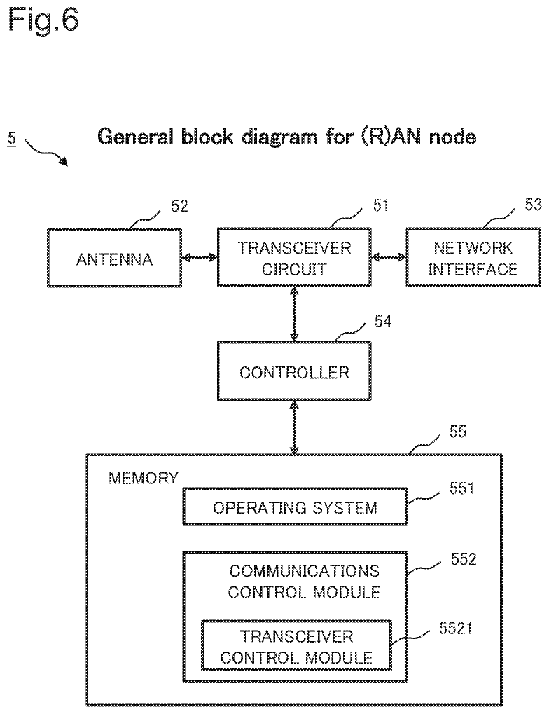

FIG. 6 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case. The controller 54 is also configured (by software or hardware) to handle related tasks such as, when implemented, UE mobility estimates and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

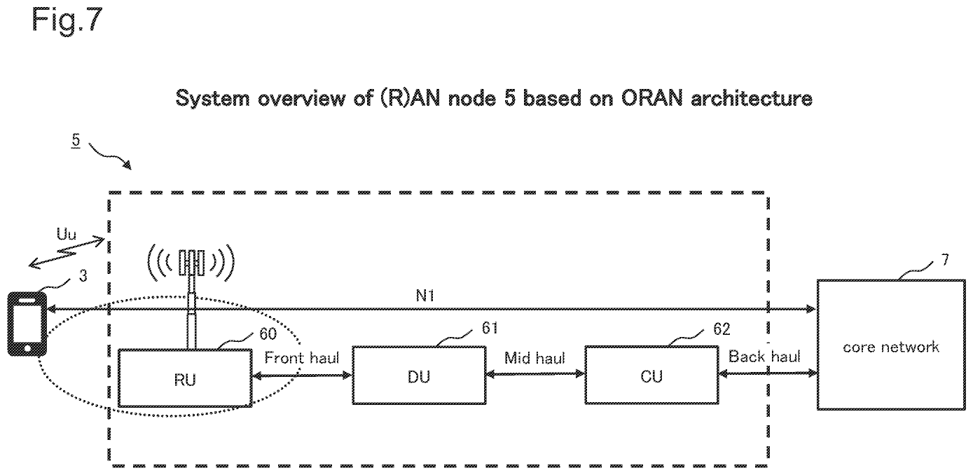

FIG. 7 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

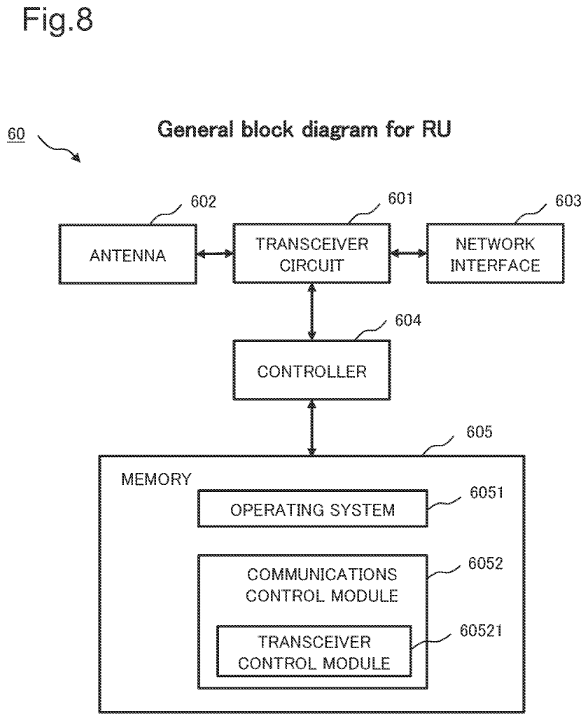

FIG. 8 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimates and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit.

Any functionality in the description for the RU 60 can be implemented in the integrated/combined unit above.

### <Distributed Unit (DU)>

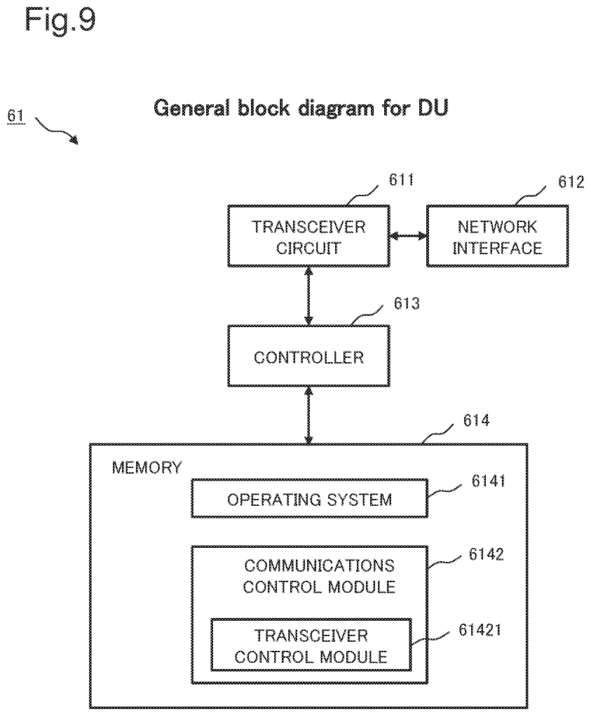

FIG. 9 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

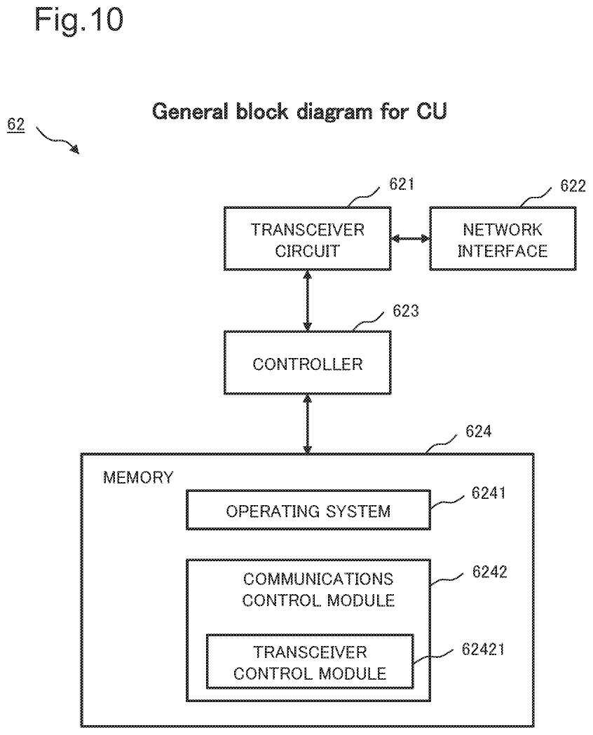

FIG. 10 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit.

Any functionality in the description for the CU 62 can be implemented in the integrated/combined unit above.

### <AMF>

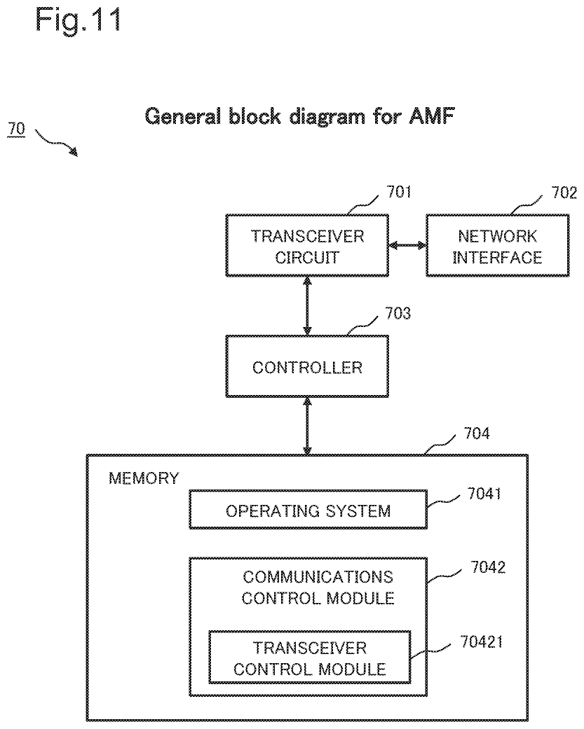

FIG. 11 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <SMF>

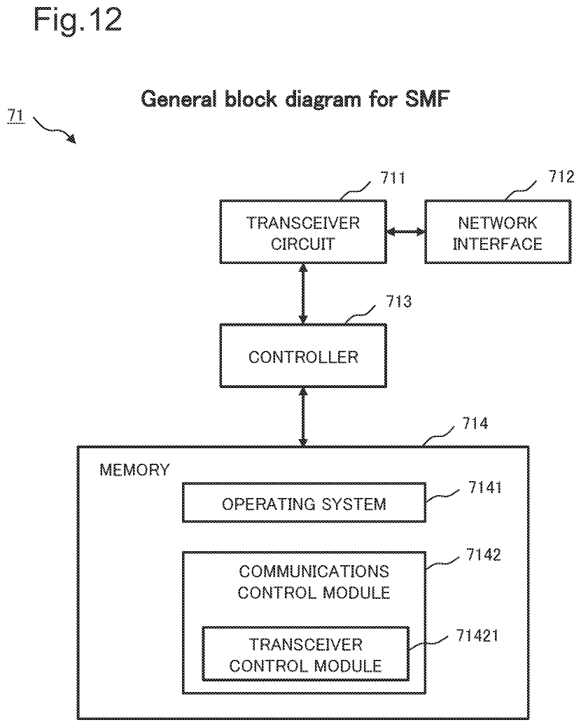

FIG. 12 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable data storage device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

Note that SMF+PGW-C may have same components to the SMF 71. For example, the SMF+PGW-C is apparatus or node having function for the SMF 71 and function for the PGW-C. The function of the PGW-C can be achieved by the components of the SMF+PGW-C.

Note that V-SMF may have same components to the SMF 71. The function of the V-SMF can be achieved by the components of the SMF+PGW-C.

### <UDM>

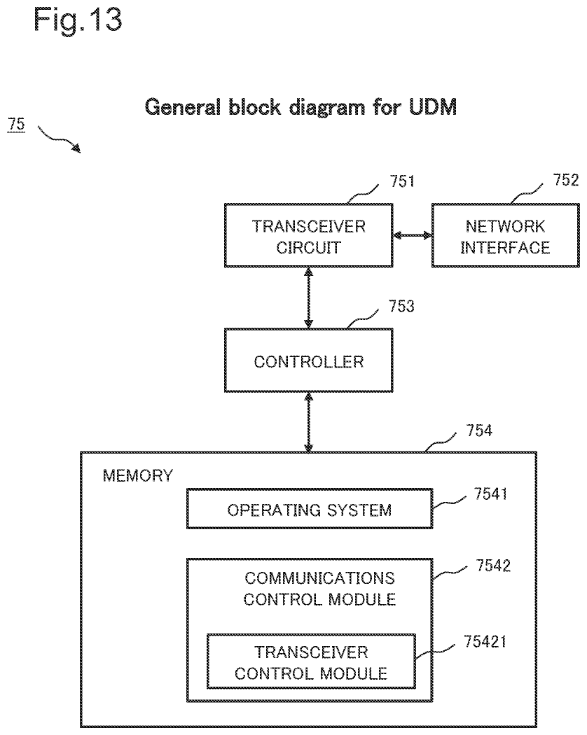

FIG. 13 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NSACF>

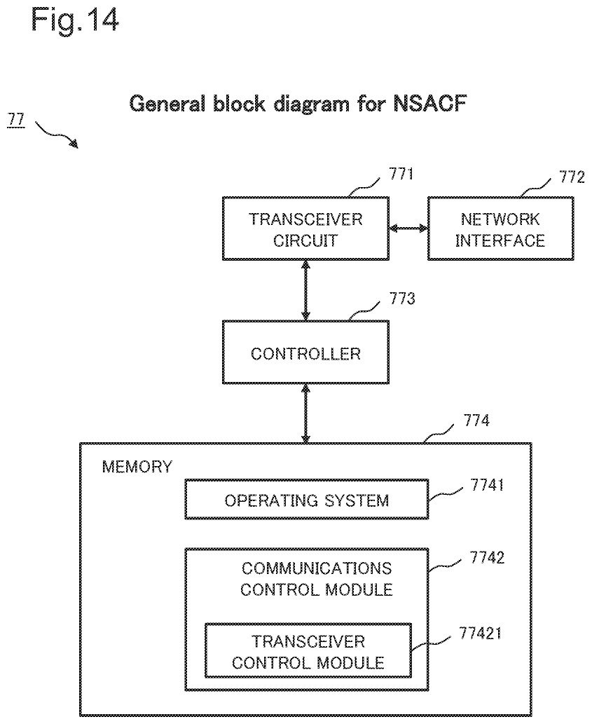

FIG. 14 is a block diagram illustrating the main components of the NSACF 77. As shown, the apparatus includes a transceiver circuit 771 which is operable to transmit signals to and to receive signals from other nodes (including the AMF 70 and SMF 71) via a network interface 772. A controller 773 controls the operation of the NSACF 77 in accordance with the software stored in a memory 774. The Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NSACF 77 and other nodes, such as the AMF 70 and other core network nodes (including core network nodes in the HPLMN of the UE 3 when the UE 3 is roaming-in.

Such signalling may include, for example, appropriately formatted signalling messages (e.g. a HTTP restful methods based on the service based interfaces) relating to network data analytics function procedures (for the UE 3).

The NSACF 77 may support the Non-Public Network (NPN), The NPN may be a Stand-alone Non-Public Network (SNPN) or a Public Network Integrated NPN (PNI-NPN).

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS.

The whole or part of the Aspects disclosed above can be described as, but not limited to, the following.

<5.15.11.14 Support of Network Slice Admission Control and Interworking with EPC>

If EPS counting is required for a network slice, the Network Slice Admission Control for maximum number of UEs and/or for maximum number of PDU Sessions per network slice is performed at the time of PDN connection establishment in case of EPC interworking. To support the NSAC for maximum number of UEs and/or for maximum number of PDU Sessions per network slice in EPC, the SMF+PGW-C is configured with the information indicating which network slice is subject to NSAC. During PDN connection establishment in EPC, the SMF+PGW-C selects an S-NSSAI associated with the PDN connection as described in clause 5.15.7.1. If the selected S-NSSAI by the SMF+PGW-C is subject to the NSAC, the SMF+PGW-C triggers interaction with NSACF to check the availability of the network slice, before the SMF+PGW-C provides the selected S-NSSAI to the UE. If the network slice is available, the SMF+PGW-C continues to proceed with the PDN connection establishment procedure.

The NSACF performs the following for checking network slice availability prior to returning a response to the SMF+PGW-C:

If:
the UE identity is already included in the list of UE IDs registered with a network slice (if Network Slice Admission Control for maximum number of UEs is applicable) and the current number of PDU sessions is below the maximum number (if Network Slice Admission Control for maximum number of sessions is applicable); or
the UE identity is not included in the list of UE IDs registered with a network slice and the current number of UE registration did not reach the maximum number (if Network Slice Admission Control for maximum number of UEs is applicable), and the current number of PDU sessions did not reach the maximum number (if Network Slice Admission Control for maximum number of sessions is applicable);
then the NSACF responds to the SMF+PGW-C with the information that the network slice is available. The NSACF includes the UE identity in the list of UE IDs if not already on the list and increases the current number of UE registration (if Network Slice Admission Control for maximum number of UEs is applicable) and increases the current number of PDU sessions (if Network Slice Admission Control for maximum number of sessions is applicable).

When the UE with ongoing PDN connection(s) moves from EPC to 5GC, the SMF+PGW-C indicates to the AMF that NSAC status granted indication. Unless the AMF receives the NSAC status granted indication, the AMF triggers a request to increase the number of the UE registration in NSACF when the UE is registered in the new AMF.

NOTE 1: The SMF+PGW-C or the AMF does not interwork with the NSACF for Network Slice Admission Control for UE as far as both 5GS and EPS support Network Slice Admission Control.

NOTE 2: The SMF+PGW-C does not interwork with the NSACF for Network Slice Admission Control for PDU session(s) as far as both 5GS and EPS support Network Slice Admission Control.

When the UE with ongoing PDN connection(s) moves from EPC to 5GC, or from 5GC to EPC, the session continuity is guaranteed as the admission was granted at the time of PDN connection establishment, i.e. the number of PDU session is not counted again in 5GC.

If the PDN connection associated with S-NSSAI is released in EPC, the SMF+PGW-C triggers a request (i.e. decrease) to NSACF for maximum number of PDU sessions per network slice control. The NSACF determines to decrease the current number of registrations and remove the UE identity from the list of UE IDs if the PDN connection(s) associated with S-NSSAI are all released in EPC.

Editor's note: It is FFS whether one NSACF is in charge of registration and session admission control, or there are respective NSCAFs for registration and session admission control, depending on the deployment scenarios.

NOTE 3: Network Slice Admission Control in EPC is not performed for the attachment without PDN connectivity.

If EPS counting is not required for a network slice, the Network Slice Admission Control for maximum number of UEs and/or for maximum number of PDU Sessions per network slice is performed when the UE moves from EPC to 5GC. The SMF+PGW-C is configured with the information indicating the network slice is subject to NSAC only in 5GS.

For Network Slice Admission Control for PDU session(s), when the UE performs mobility Registration procedure from EPC to 5GC (Network Slice Admission Control for maximum number of UEs per network slice) and/or when the PDN connections are handed over from EPC to 5GC (Network Slice Admission Control for maximum number of PDU Sessions per network slice), the SMF+PGW-C interacts with the NSACF to register the PDU Session(s) from the network slice as described in clause 5.15.11.2. The PDN connection interworking procedure is performed as described in clause 5.15.7.1.

For Network Slice Admission Control for UE, when the UE performs mobility Registration procedure from EPC to 5GC (Network Slice Admission Control for maximum number of UEs per network slice) and/or when the PDN connections are handed over from EPC to 5GC (Network Slice Admission Control for maximum number of PDU Sessions per network slice), the SMF+PGW-C informs a NSAC counting indicator to the AMF indicating that the Network Slice Admission Control for UE has been taken place in the EPS. Unless the AMF receives the NSAC counting indicator, The AMF interacts with the NSACF to register the UE from the network slice as described in clause 5.15.11.1.

Editor's note: It is FFS whether and how to support session continuity if either the current number of UE registration or the current number of PDU sessions reaches the maximum number when the UE moves from EPC to 5GC.

### <4.11.1.2.1 5GS to EPS Handover Using N26 Interface>

FIG. 4.11.1.2.1-1 describes the handover procedure from 5GS to EPS when N26 is supported.

In the case of handover to a shared EPS network, the source NG-RAN determines a PLMN to be used in the target network as specified by TS 23.501 [2]. The source NG-RAN shall indicate the selected PLMN ID to be used in the target network to the AMF as part of the TAI sent in the HO Required message.

In the case of handover from a shared NG-RAN, the AMF may provide the MME with an indication that the 5GS PLMN is a preferred PLMN at later change of the UE to a 5GS shared networks.

During the handover procedure, as specified in clause 4.9.1.3.1, the source AMF shall reject any SMF+PGW-C initiated N2 request received since handover procedure started and shall include an indication that the request has been temporarily rejected due to handover procedure in progress.

Upon reception of a rejection for an SMF+PGW-C initiated N2 request(s) with an indication that the request has been temporarily rejected due to handover procedure in progress, the SMF+PGW-C behaves as specified in TS 23.401 [13].

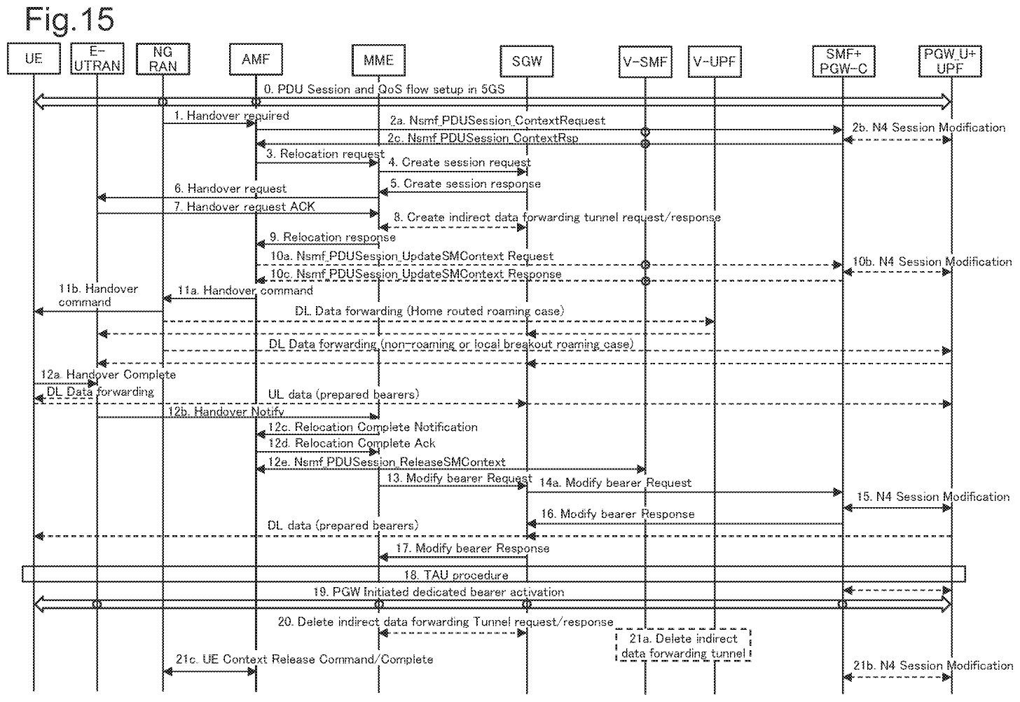

FIG. 4.11.1.2.1-1: 5GS to EPS handover for single-registration mode with N26 interface (See FIG. 15)

The procedure involves a handover to EPC and setup of default EPS bearer and dedicated bearers for QoS Flows that have EBI assigned, in EPC in steps 1-16 and re-activation, if required, of dedicated EPS bearers for non-GBR QoS Flows that have no EBI assigned, in step 19. This procedure can be triggered, for example, due to new radio conditions, load balancing or in the presence of QoS Flow for normal voice or IMS emergency voice, the source NG-RAN node may trigger handover to EPC.

For Ethernet and Unstructured PDU Session Types, the PDN Type Ethernet and non-IP respectively are used, when supported, in EPS.

When EPS supports PDN Type non-IP but not PDN type Ethernet, PDN type non-IP is used also for Ethernet PDU sessions. The SMF shall also set the PDN Type of the EPS Bearer Context to non-IP in this case. After the handover to EPS, the PDN Connection will have PDN Type non-IP, but it shall be locally associated in UE and SMF to PDU Session Type Ethernet or Unstructured respectively.

In the roaming home routed case, the SMF+PGW-C always provides the EPS Bearer ID and the mapped QoS parameters to UE. The V-SMF caches the EPS Bearer ID and the mapped QoS parameters obtained from H-SMF for this PDU session. This also applies in the case that the HPLMN operates the interworking procedure without N26.

NOTE 1: The IP address preservation cannot be supported, if SMF+PGW-C in the HPLMN doesn't provide the mapped QoS parameters.

If NSAC is not supported in EPS for a PDU session, the AMF interacts with the NSACF to deregister the UE for network slice and the SMF+PGW-C interacts with the NSACF to deregister the PDU Session(s) from the network slice, if subject to NSAC in 5GS.

1. NG-RAN decides that the UE should be handed over to the E-UTRAN. If NG-RAN is configured to perform Inter RAT mobility due to IMS voice fallback triggered by QoS flow setup and request to setup QoS flow for IMS voice was received, NG-RAN responds indicating rejection of the QoS flow establishment because of mobility due to fallback for IMS voice via N2 SM information and triggers handover to E-UTRAN. The NG-RAN sends a Handover Required (Target eNB ID, Direct Forwarding Path Availability, Source to Target Transparent Container, inter system handover indication) message to the AMF. NG-RAN indicates bearers corresponding to the 5G QoS Flows for data forwarding in Source to Target Transparent Container.

If the source NG RAN and target E-UTRAN support RACS as defined in TS 23.501 [2], the Source to Target transparent container need not carry the UE radio access capabilities (instead the UE Radio Capability ID is supplied from the CN to the target E-UTRAN). However, if the source NG-RAN has knowledge that the target E-UTRAN might not have a local copy of the Radio Capability corresponding to the UE Radio Capability ID (i.e. because the source NG-RAN had itself to retrieve the UE's Radio Capability from the AMF) then the source NG-RAN may also send some (or all) of the UE's Radio Capability to the target E-UTRAN (the size limit based on configuration). In the case of inter-PLMN handover, when the source NG-RAN and target E-UTRAN support RACS as defined in TS 23.501 [2] and TS 23.401 [13], and the source NG-RAN determines that the target PLMN does not support the UE Radio Capability ID assigned by the source PLMN based on local configuration, then the source NG-RAN includes the UE radio access capabilities in the Source to Target transparent container.

Direct Forwarding Path Availability indicates whether direct forwarding is available from the NG-RAN to the E-UTRAN. This indication from NG-RAN can be based on e.g. the presence of IP connectivity and security association(s) between the NG-RAN and the E-UTRAN.

If the handover is triggered due to Emergency fallback, the NG-RAN may forward the Emergency indication to the target eNB in the Source to Target Transparent Container, and the target eNB allocates radio bearer resources taking received indication into account.

2a-2c. The AMF determines from the ‘Target eNB Identifier’ IE that the type of handover is Handover to E-UTRAN. The AMF selects an MME as described in TS 23.401 [13] clause 4.3.8.3.

The AMF determines for a PDU Session whether to retrieve context including mapped UE EPS PDN Connection from the V-SMF (in the case of HR roaming) or the SMF+PGW-C (in the case of non roaming or LBO roaming) as follows:
If the AMF determines that one or more of the EBI(s) can be transferred, the AMF sends Nsmf_PDUSession_ContextRequest to the V-SMF or SMF+PGW-C and includes in the message EBI value(s) if any that cannot be transferred.
The EBI values(s) that cannot be transferred is determined by the AMF if the target MME does not support 15 EPS bearers, i.e. the AMF determines the EBI values in range 1-4 as not to be transferred to EPS, and if there are still more than 8 EBI values associated with PDU Sessions, the AMF then determines EBI value(s) not to be transferred to EPS based on S-NSSAI and ARP as specified in clause 5.17.2.2.1 of TS 23.501 [2].
The AMF does not retrieve the context for a PDU Session that cannot be transferred to EPS due to no EBI allocated, or allocated EBIs not transferrable, or combination of the two.

When the AMF sends Nsmf_PDUSession_ContextRequest the AMF provides also the target MME capability to the V-SMF or the SMF+PGW-C to allow it to determine whether to include EPS Bearer context for Ethernet PDN Type or non-IP PDN Type or not.

When Nsmf_PDUSession_Context Request is received in the V-SMF or the SMF+PGW-C, the V-SMF or the SMF+PGW-C provides context that includes the mapped EPS PDN Connection as follows:
If there is EBI list not to be transferred, and the EBI value of the QoS Flow associated with the default QoS Rule is included in that list, the V-SMF or the SMF+PGW-C shall not return the PDN Connection context (which implies the whole PDU Session is not transferred to EPS), otherwise if the EBI value of the QoS Flow associated with the default QoS Rule is not included in EBI list not to be transferred, the V-SMF or PGW C+SMF shall not provide the EPS bearer context(s) mapped from QoS Flow(s) associated with the EBI list not to be transferred.
For PDU Sessions with PDU Session Type Ethernet, if the UE and target MME supports Ethernet PDN type, the V-SMF or the PGW C+SMF provides Context for Ethernet PDN Type, otherwise if the target MME does not support Ethernet Type but support non-IP Type, the V-SMF or the PGW C+SMF provides Context for non-IP PDN Type. For PDU Sessions with PDU Session Type Unstructured, the V-SMF or the SMF+PGW-C provides Context for non-IP PDN Type.

In the case of non roaming or LBO roaming, when Nsmf_PDUSession_ContextRequest is received in PGW C+SMF, if the SMF+PGW-C determines that EPS Bearer Context can be transferred to EPS and the CN Tunnel Info for EPS bearer(s) have not been allocated before, the SMF+PGW-C sends N4 Session modification to the PGW-U+UPF to establish the CN tunnel for each EPS bearer and provides EPS Bearer Contexts to AMF, as described in step 8 of clause 4.11.1.4.1. The PGW-U+UPF is ready to receive the uplink packet from E-UTRAN.

This step is performed with all the SMF+PGW-Cs corresponding to PDU Sessions of the UE which are associated with 3GPP access and have at least one EBI(s) determined to be transferred to EPS.

NOTE 2: The AMF knows the MME capability to support 15 EPS bearers, Ethernet PDN type and/or non-IP PDN type or not through local configuration.

In home routed roaming scenario, the UE's EPS PDN Contexts are obtained from the V-SMF. If Small Data Rate Control applies on PDU Session, the V-SMF retrieves the SM Context, including Small Rate Control Status information from the H-SMF using Nsmf_PDUSession_Context Request.

If EPS supports NSAC for the PDU Session, the SMF+PGW-C includes the NSAC support indicator in the Nsmf_PDUSession_ContextResponse.

3. The AMF sends a Forward Relocation Request as in step 3 in clause 5.5.1.2.2 (S1-based handover, normal) in TS 23.401 [13], with the following modifications and clarifications:
Parameter “Return preferred” may be included. Return preferred is an optional indication by the MME of a preferred return of the UE to the 5GS PLMN at a later access change to a 5GS shared network. An MME may use this information as specified by TS 23.501 [2].
The SGW address and TEID for both the control-plane or EPS bearers in the message are such that target MME selects a new SGW.
The AMF determines, based on configuration and the Direct Forwarding Path Availability, the Direct Forwarding Flag to inform the target MME whether direct data forwarding is applicable.
The AMF includes the mapped SM EPS UE Contexts for PDU Sessions with and without active UP connections.
Subject to operator policy if the secondary RAT access restriction condition is the same for EPS and 5GS, the AMF may set EPS secondary RAT access restriction condition based on the UE's subscription data.

4-5. Step 4 and 4a respectively in clause 5.5.1.2.2 (S1-based handover, normal) in TS 23.401 [13].

6. Step 5 (Handover Request) in clause 5.5.1.2.2 (S1-based handover, normal) in TS 23.401 [13] with the following modification:
Handover Request may contain information Handover Restriction List with information about PLMN IDs as specified by TS 23.251 [35], clause 5.2a for eNodeB functions.
The target eNB should establish E-RABs indicated by the list of EPS bearer to be setup provided by the MME, even if they are not included in the source to target container.

7-9. Step 5a through 7 in clause 5.5.1.2.2 (S1-based handover, normal) in TS 23.401 [13].

10a. If data forwarding applies, the AMF sends the Nsmf_PDUSession_UpdateSMContext Request (data forwarding information) to the SMF+PGW-C. If multiple SMF+PGW-Cs serves the UE, the AMF maps the EPS bearers for Data forwarding to the SMF+PGW-C address(es) based on the association between the EPS bearer ID(s) and PDU Session ID(s). In home-routed roaming case, the AMF requests the V-SMF to create indirect forwarding tunnel if indirect forwarding applies.

10b. If indirect data forwarding applies, the SMF+PGW-C may select an intermediate PGW-U+UPF for data forwarding. The SMF+PGW-C maps the EPS bearers for Data forwarding to the 5G QoS flows based on the association between the EPS bearer ID(s) and QFI(s) for the QoS flow(s) in the SMF+PGW-C, and then sends the QFIs, Serving GW Address(es) and TEID(s) for data forwarding to the PGW-U+UPF. The CN Tunnel Info is provided by the PGW-U+UPF to SMF+PGW-C in this response. In home-routed roaming case, the V-SMF selects the V-UPF for data forwarding.

10c. The SMF+PGW-C returns an Nsmf_PDUSession_UpdateSMContext Response (Cause, Data Forwarding tunnel Info, QoS flows for Data Forwarding). Based on the correlation between QFI(s) and Serving GW Address(es) and TEID(s) for data forwarding, the PGW-U+UPF maps the QoS flow(s) into the data forwarding tunnel(s) in EPC.

11. The AMF sends the Handover Command to the source NG-RAN (Transparent container (radio aspect parameters that the target eNB has set-up in the preparation phase), Data forwarding tunnel info, QoS flows for Data Forwarding). The source NG-RAN commands the UE to handover to the target Access Network by sending the HO Command. The UE correlates the ongoing QoS Flows with the indicated EPS Bearer IDs to be setup in the HO command. The UE locally deletes the PDU Session if the QoS Flow associated with the default QoS rule in the PDU Session does not have an EPS Bearer ID assigned. If the QoS Flow associated with the default QoS rule has an EPS Bearer ID assigned, the UE keeps the PDU Session (PDN connection) and for the remaining QoS Flow(s) that do not have EPS bearer ID(s) assigned, the UE locally deletes the QoS rule(s) and the QoS Flow level QoS parameters if any associated with those QoS Flow(s) and notifies the impacted applications that the dedicated QoS resource has been released. The UE deletes any UE derived QoS rules. The EPS Bearer ID that was assigned for the QoS flow of the default QoS rule in the PDU Session becomes the EPS Bearer ID of the default bearer in the corresponding PDN connection.

If indirect data forwarding is applied, Data forwarding tunnel info includes CN tunnel info for data forwarding per PDU session. For the QoS Flows indicated in the “QoS Flows for Data Forwarding”, NG-RAN initiate data forwarding via to the PGW-U+UPF based on the CN Tunnel Info for Data Forwarding per PDU Session. Then the PGW-U+UPF maps data received from the data forwarding tunnel(s) in the 5GS to the data forwarding tunnel(s) in EPS, and sends the data to the target eNodeB via the Serving GW.

If direct data forwarding is applied, Data forwarding tunnel info includes E-UTRAN tunnel info for data forwarding per EPS bearer. NG-RAN initiate data forwarding to the target E-UTRAN based on the Data Forwarding Tunnel Info for Data Forwarding per EPS bearer.

12-12c. Step 13 to step 14 from clause 5.5.1.2.2 (S1-based handover, normal) in TS 23.401 [13] with the following clarification:
The AMF requests the release of the PDU Session which is associated with 3GPP access and not expected to be transferred to EPC, i.e. the AMF requests the release of:
PDU Session(s) whose corresponding SMF+PGW-C(s) are not contacted by AMF for SM context because the AMF determines that none of EBI(s) for the PDU Session can be transferred to EPS at step 2a; and
PDU Session(s) for which the SM context retrieval failed at step 2c.

12d. The AMF acknowledges MME with Relocation Complete Ack message. A timer in AMF is started to supervise when resource in NG-RAN shall be released.

12e. In the case of home routed roaming, the AMF invokes Nsmf_PDUSession_ReleaseSMContext Request (V-SMF only indication) to the V-SMF. This service operation request the V-SMF to remove only the SM context in V-SMF, i.e. not release PDU Session context in the SMF+PGW-C.

If indirect forwarding tunnel(s) were previously established, the V-SMF starts a timer and releases the SM context on expiry of the timer. If no indirect forwarding tunnel has been established, the V-SMF immediately releases the SM context and its UP resources for this PDU Session in V-UPF locally.

13. Step 15 from clause 5.5.1.2.2 (S1-based handover, normal) in TS 23.401 [13].

14a. Step 16 (Modify Bearer Request) from clause 5.5.1.2.2 (S1-based handover, normal) in TS 23.401 [13] with the following clarification:
If the PDU Session (PDN connection) has QoS Flows that do not have EPS bearer ID(s) assigned, or QoS Flow(s) for which the mapped EPS bearers are not included in Modify Bearer Request, the SMF+PGW-C deletes the PCC rule(s) associated with those QoS Flows and informs the PCF about the removed PCC rule(s).

NOTE 4: If the QoS flow is deleted, the IP flows of the deleted QoS rules will continue flowing on the default EPS bearer if it does not have an assigned TFT. If the default EPS bearer has an assigned TFT, the IP flows of the deleted QoS Flow may be interrupted until step 19 when dedicated bearer activation is triggered by a request from the PCF.

The SMF+PGW-C may need to report some subscribed event to the PCF by performing an SMF initiated SM Policy Association Modification procedure as defined in clause 4.16.5.

15. The SMF+PGW-C initiates a N4 Session Modification procedure towards the UPF+PGW-U to update the User Plane path, i.e. the downlink User Plane for the indicated PDU Session is switched to E-UTRAN. The SMF+PGW-C releases the resource of the CN tunnel for PDU Session in UPF+PGW-U.

16. Step 16a (Modify Bearer Response) from clause 5.5.1.2.2 (S1-based handover, normal) in TS 23.401 [13]. At this stage the User Plane path is established for the default bearer and the dedicated EPS bearers between the UE, target eNodeB, Serving GW and the PGW-U+UPF. The SMF+PGW-C uses the EPS QoS parameters as assigned for the dedicated EPS bearers during the QoS Flow establishment. SMF+PGW-C maps all the other IP flows to the default EPS bearer (see NOTE 4).

If indirect forwarding tunnel(s) were previously established, the SMF+PGW-C starts a timer, to be used to release the resource used for indirect data forwarding.

17. Step 17 from clause 5.5.1.2.2 (S1-based handover, normal) in TS 23.401 [13].

18. The UE initiates a Tracking Area Update procedure as specified in step 18 of clause 5.5.1.2.2 (S1-based handover, normal) in TS 23.401 [13].

This includes the deregistration of the old AMF for 3GPP access from the HSS+UDM as specified in clause 4.11.1.5.3. Any registration associated with the non-3GPP access in the old AMF is not removed (i.e. an AMF that was serving the UE over both 3GPP and non-3GPP accesses does not consider the UE as deregistered over non 3GPP access and will remain registered and subscribed to subscription data updates in UDM).

NOTE 5: The behaviour whereby the HSS+UDM cancels location of CN node of the another type, i.e. AMF, is similar to HSS behaviour for MME and Gn/Gp SGSN registration (see TS 23.401 [13]). The target AMF that receives the cancel location from the HSS+UDM is the one associated with 3GPP access.

When the UE decides to deregister over non-3GPP access or the old AMF decides not to maintain a UE registration for non-3GPP access anymore, the old AMF then deregisters from UDM by sending a Nudm_UECM_Deregistration service operation, unsubscribes from Subscription Data updates by sending an Nudm_SDM_Unsubscribe service operation to UDM and releases all the AMF and AN resources related to the UE.

Unless the AMF receives NSAC support indicator in step 2c, the AMF interacts with the NSACF to deregister the UE from the network slice, if subject to NSAC in 5GS.

The SMF+PGW-C may interact with the NSACF to deregister the PDU Session(s) from the network slice, if subject to NSAC in 5GS but not in EPS.

19. If PCC is deployed, the PCF may decide to provide the previously removed PCC rules to the SMF+PGW-C again thus triggering the SMF+PGW-C to initiate dedicated bearer activation procedure. This procedure is specified in TS 23.401 [13], clause 5.4.1 with modification captured in clause 4.11.1.5.4. This step is applicable for PDN Type IP or Ethernet, but not for non-IP PDN Type.

20. Step 21 from clause 5.5.1.2.2 (S1-based handover, normal) in TS 23.401 [13].

21. In the case of home routed roaming, at the expiry of the timer at V-SMF started at step 12e, the V-SMF locally releases the SM context and the UP resource for the PDU Session including the resources used for indirect forwarding tunnel(s) that were allocated at step 10.

In non-roaming or local breakout roaming, if SMF+PGW-C has started a timer in step 16, at the expiry of the timer, the SMF+PGW-C sends N4 Session Modification Request to PGW-U+UPF to release the resources used for the indirect forwarding tunnel(s) that were allocated at step 10.

When the timer set in step 12d expires, AMF also sends a UE Context Release Command message to the source NG RAN. The source NG RAN releases its resources related to the UE and responds with a UE Context Release Complete message.

### <4.11.1.2.2.1 General>

N26 interface is used to provide seamless session continuity for single registration mode.

The procedure involves a handover to 5GS and setup of QoS Flows in 5GS.

In the home routed roaming case, the PGW-C+SMF in the HPLMN always receives the PDU Session ID from UE and provides PDN Connection associated 5G QoS parameter(s) and S-NSSAI to the UE. This also applies in the case that the HPLMN operates the interworking procedure without N26.

In the case of handover to a shared 5GS network, the source E-UTRAN determines a PLMN to be used in the target network as specified by TS 23.251 [35] clause 5.2a for eNodeB functions. A supporting MME may provide the AMF via N26 with an indication that source EPS PLMN is a preferred PLMN when that PLMN is available at later change of the UE to an EPS shared network.

NOTE 1: If the UE has active EPS bearer for normal voice or IMS emergency voice, the source E-UTRAN can be configured to not trigger any handover to 5GS.

If the PDN Type of a PDN Connection in EPS is non-IP, and is locally associated in UE and SMF to PDU Session Type Ethernet or Unstructured, the PDU Session Type in 5GS shall be set to Ethernet or Unstructured respectively.

NOTE 2: If the non-IP PDN Type is locally associated in UE and SMF to PDU Session Type Ethernet, it means that Ethernet PDN Type is not supported in EPS.

NOTE 3: The IP address continuity can't be supported, if SMF+PGW-C in the HPLMN doesn't provide the mapped QoS parameters.

If NSAC is not supported in EPS, the AMF interacts with the NSACF to register the UE for network slice and the SMF+PGW-C interacts with the NSACF to register the PDU Session(s) from the network slice, if subject to NSAC in 5GS.

### <4.11.1.2.2.3 Execution Phase>

FIG. 4.11.1.2.2.3-1 shows the Single Registration-based Interworking from EPS to 5GS procedure.

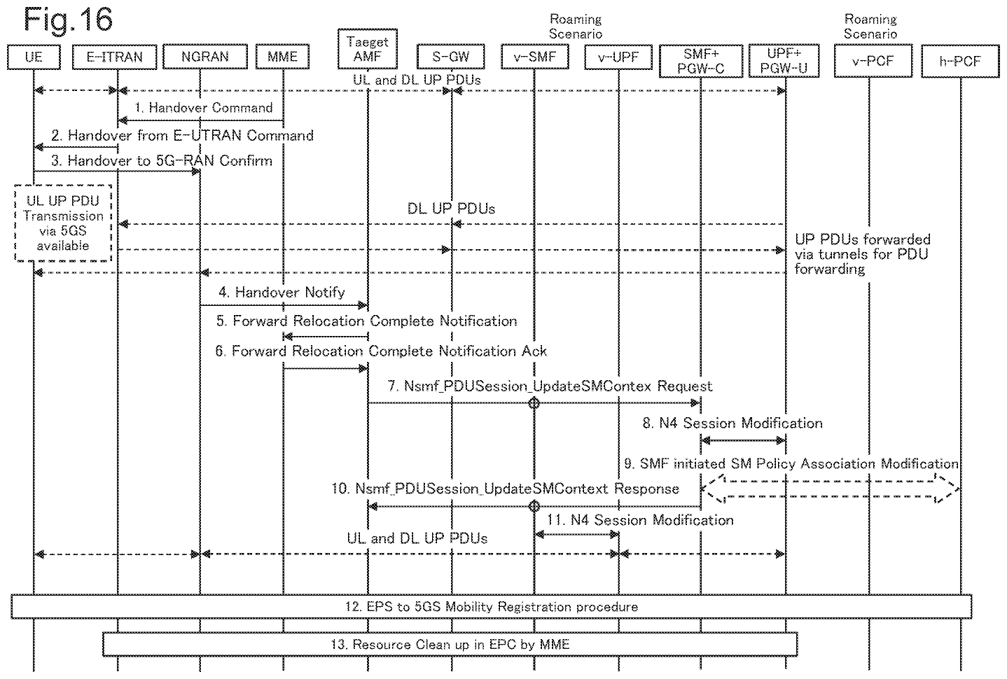

FIG. 4.11.1.2.2.3-1: EPS to 5GS handover using N26 interface, execution phase (See FIG. 16)

NOTE: Step 6 P-GW-C+SMF Registration in the UDM is not shown in the figure for simplicity.

1-2. Step 9-11 from clause 5.5.1.2.2 (S1-based handover, normal) in TS 23.401 [13]. Different from step 9a of clause 5.5.1.2.2 (S1-based handover, normal) in TS 23.401 [13], upon reception of Handover Command, the UE will keep the QoS Flow context for which it did not receive the corresponding radio resources in the NG-RAN until the QoS Flow is released by the network using PDU Session Modification procedure in clause 4.3.3. If the QoS Flow with a default QoS Rule of a PDU Session does not have the corresponding radio resources in the NG-RAN, UE considers that the user plane of this PDU Session is deactivated.

3. Handover Confirm: the UE confirms handover to the NG-RAN.

The UE moves from the E-UTRAN and synchronizes with the target NG-RAN. The UE may resume the uplink transmission of user plane data only for those QFIs and Session IDs for which there are radio resources allocated in the NG-RAN.

The E-UTRAN sends DL data to the Data Forwarding address received in step 1. If the indirect data forwarding is applied, the E-UTRAN forward the DL data to NG-RAN via the SGW and the v-UPF. The v-UPF forwards the data packets to the NG-RAN using the N3 Tunnel Info for data forwarding, adding the QFI information. The target NG-RAN prioritizes the forwarded packets over the fresh packets for those QoS flows for which it had accepted data forwarding.

If Direct data forwarding is applied, the E-UTRAN forwards the DL data packets to the NG-RAN via the direct data forwarding tunnel.

4. Handover Notify: the NG-RAN notifies to the target AMF that the UE is handed over to the NG-RAN.

5. Then the target AMF knows that the UE has arrived to the target side and informs the MME by sending a Forward Relocation Complete Notification message.

6. Step 14 from clause 5.5.1.2.2 (S1-based handover, normal) in TS 23.401 [13].

7. Target AMF to SMF+PGW-C (V-SMF in the case of roaming and Home-routed case):

Nsmf_PDUSession_UpdateSMContext Request (Handover Complete Indication for PDU Session ID). In the Home-routed roaming case, the V-SMF invokes Nsmf_PDUSession_Update Request (V-CN Tunnel Info, Handover Complete Indication) to SMF+PGW-C.

Handover Complete Indication is sent per each PDU Session to the corresponding SMF+PGW-C (sent by V-SMF in the roaming and Home-routed case) to indicate the success of the N2 Handover.

If indirect forwarding is used, a timer in SMF+PGW-C (V-SMF in the case of roaming and Home-routed case) is started to supervise when resources in UPF (for indirect data forwarding) shall be released.

8. The SMF+PGW-C updates the UPF+PGW-U with the V-CN Tunnel Info, indicating that downlink User Plane for the indicated PDU Session is switched to NG-RAN or V-UPF in the case of roaming in Home-routed case and the CN tunnels for EPS bearers corresponding to the PDU session can be released.

For each EPS Bearer one or more “end marker” is sent to Serving GW by the UPF+PGW-U immediately after switching the path. The UPF+PGW-U starts sending downlink packets to the V-UPF.

9. If PCC infrastructure is used, the SMF+PGW-C informs the PCF about the change of, for example, the RAT type and UE location.

10. SMF+PGW-C to target AMF: Nsmf_PDUSession_UpdateSMContext Response (PDU Session ID, NSAC counting indicator).

SMF+PGW-C confirms reception of Handover Complete.
If the SMF has not yet registered for this PDU Session ID, then the SMF registers with the UDM using Nudm_UECM_Registration (SUPI, DNN, PDU Session ID) for a given PDU Session as in step 4 of PDU Session Establishment Procedure in clause 4.3.2.

11. For home-routed roaming scenario: The V-SMF provides to the v-UPF with the N3 DL AN Tunnel Info. This step is executed after step 7.

12. The UE performs the EPS to 5GS Mobility Registration Procedure from step 2 in clause 4.11.1.3.3. The UE includes the UE Policy Container containing the list of PSIs, indication of UE support for ANDSP and OSId if available. If the UE holds a native 5G-GUTI it also includes the native 5G-GUTI as an additional GUTI in the Registration Request. The UE shall select the 5G-GUTI for the additional GUTI as follows, listed in decreasing order of preference:
a native 5G-GUTI assigned by the PLMN to which the UE is attempting to register, if available;
a native 5G-GUTI assigned by an equivalent PLMN to the PLMN to which the UE is attempting to register, if available;
a native 5G-GUTI assigned by any other PLMN, if available.

The additional GUTI enables the target AMF to find the UE's 5G security context (if available). The target AMF provides NG-RAN with a PLMN list in the Handover Restriction List containing at least the serving PLMN, taking into account of the last used EPS PLMN ID and Return preferred indication as part of the Registration procedure execution and target AMF signalling to NG-RAN. The Handover Restriction List contains a list of PLMN IDs as specified by TS 23.501 [2].

Unless NSAC counting indicator is included in Nsmf_PDUSession_UpdateSMContext Response in step 10, the AMF interacts with the NSACF to register the UE for network slice, if subject to NSAC in 5GC.

The SMF+PGW-C may interact with the NSACF to register the PDU Session(s) from the network slice, if subject to NSAC in 5GS but not in EPS.

13. Step 19 from clause 5.5.1.2.2 (S1-based handover, normal) in TS 23.401 [13]. Step 20a-20b from clause 5.5.1.2.2 (S1-based handover, normal) in TS 23.401 [13], with the following modification:

For the PDN connections that are not possible to be transferred to 5GS (e.g. PDN connections are anchored in a standalone PGW), the MME initiates PDN connection release procedure as specified in TS 23.401 [13].

14. If indirect forwarding was used, then the expiry of the timer started at step 7 triggers the SMF+PGW-C (V-SMF in the case of roaming and Home-routed case) to release temporary resources used for indirect forwarding that were allocated at steps 11 to 13 in clause 4.11.1.2.2.2.

The whole or part of the example Aspects disclosed above can be described as, but not limited to, the following supplementary notes.

supplementary note 1. A method of an apparatus related to Session Management Function (SMF) comprising:
sending, to an Access and Mobility Management Function (AMF) apparatus, a first message,
wherein the first message includes information indicating that the apparatus interacted with a Network Slice Admission Control Function (NSACF) apparatus for Network Slice Admission Control (NSAC); and
retaining a second message for the NSAC to be sent to the NSACF in a case where the first message includes the information.

supplementary note 2. A method of an apparatus related to Session Management Function (SMF) comprising:
sending, to an Access and Mobility Management Function (AMF) apparatus, a first message; and
sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

supplementary note 3. A method of an Access and Mobility Management Function (AMF) apparatus comprising:
receiving, from an apparatus related to Session Management Function (SMF), a first message,
wherein the first message includes information indicating that the apparatus interacted with a Network Slice Admission Control Function (NSACF) apparatus for Network Slice Admission Control (NSAC); and
retaining a second message for the NSAC to be sent to the NSACF in a case where the first message includes the information.

supplementary note 4. A method of an Access and Mobility Management Function (AMF) apparatus comprising:
receiving, from an apparatus related to Session Management Function (SMF), a first message; and
sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

supplementary note 5. A method of an apparatus related to Session Management Function (SMF) comprising:
communicating with an Access and Mobility Management Function (AMF) apparatus; and
sending, to the AMF apparatus, a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC.

supplementary note 6. A method of an Access and Mobility Management Function (AMF) apparatus comprising:
receiving, from an apparatus related to Session Management Function (SMF), a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC; and
retaining a second message for the NSAC to be sent to the NSACF in a case where the first message includes the first information and the second information.

supplementary note 7. A method of an Access and Mobility Management Function (AMF) apparatus comprising:
receiving, from an apparatus related to Session Management Function (SMF), a first message; and
sending, to a Network Slice Admission Control Function (NSACF) apparatus, a second message for a Network Slice Admission Control (NSAC) in a case where the first message does not include first information indicating that the apparatus is capable for the NSAC and second information indicating that the apparatus interacted with the NSACF apparatus for the NSAC.

supplementary note 8. A method of an Access and Mobility Management Function (AMF) apparatus comprising:
receiving, from an apparatus related to Session Management Function (SMF), a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC; and
sending, to the apparatus, a second message,
wherein the second message includes the first information and the second information.

supplementary note 9. A method of an apparatus related to Session Management Function (SMF) comprising:
sending, to an Access and Mobility Management Function (AMF) apparatus, a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC; and
retaining a second message for the NSAC to be sent to the NSACF in a case where the apparatus sends the first message to the AMF apparatus.

supplementary note 10. A method of an apparatus related to Session Management Function (SMF) comprising:
sending, to an Access and Mobility Management Function (AMF) apparatus, a first message; and
sending, to a Network Slice Admission Control Function (NSACF) apparatus, a second message for a Network Slice Admission Control (NSAC) in a case where the first message does not include first information indicating that a second apparatus related to SMF is capable for the NSAC and second information related to interaction between the second apparatus and the NSACF apparatus for the NSAC.

supplementary note 11. An apparatus related to Session Management Function (SMF) comprising:
means for sending, to an Access and Mobility Management Function (AMF) apparatus, a first message,
wherein the first message includes information indicating that the apparatus interacted with a Network Slice Admission Control Function (NSACF) apparatus for Network Slice Admission Control (NSAC); and
means for retaining a second message for the NSAC to be sent to the NSACF in a case where the first message includes the information.

supplementary note 12. An apparatus related to Session Management Function (SMF) comprising:
means for sending, to an Access and Mobility Management Function (AMF) apparatus, a first message; and
means for sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

supplementary note 13. An Access and Mobility Management Function (AMF) apparatus comprising:
means for receiving, from an apparatus related to Session Management Function (SMF), a first message,
wherein the first message includes information indicating that the apparatus interacted with a Network Slice Admission Control Function (NSACF) apparatus for Network Slice Admission Control (NSAC); and
means for retaining a second message for the NSAC to be sent to the NSACF in a case where the first message includes the information.

supplementary note 14. An Access and Mobility Management Function (AMF) apparatus comprising:
means for receiving, from an apparatus related to Session Management Function (SMF), a first message; and
means for sending, to a Network Slice Admission Control Function (NSACF) apparatus, a second message for a Network Slice Admission Control (NSAC) in a case where the first message does not include information indicating that the apparatus interacted with the NSACF apparatus for the NSAC.

supplementary note 15. An apparatus related to Session Management Function (SMF) comprising:
means for communicating with an Access and Mobility Management Function (AMF) apparatus; and
means for sending, to the AMF apparatus, a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC.

supplementary note 16. An Access and Mobility Management Function (AMF) apparatus comprising:
means for receiving, from an apparatus related to Session Management Function (SMF), a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC; and
means for retaining a second message for the NSAC to be sent to the NSACF in a case where the first message includes the first information and the second information.

supplementary note 17. An Access and Mobility Management Function (AMF) apparatus comprising:
means for receiving, from an apparatus related to Session Management Function (SMF), a first message; and
means for sending, to a Network Slice Admission Control Function (NSACF) apparatus, a second message for a Network Slice Admission Control (NSAC) in a case where the first message does not include first information indicating that the apparatus is capable for the NSAC and second information indicating that the apparatus interacted with the NSACF apparatus for the NSAC.

supplementary note 18. An Access and Mobility Management Function (AMF) apparatus comprising:
means for receiving, from an apparatus related to Session Management Function (SMF), a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC; and
means for sending, to the apparatus, a second message,
wherein the second message includes the first information and the second information.

supplementary note 19. An apparatus related to Session Management Function (SMF) comprising:
means for sending, to an Access and Mobility Management Function (AMF) apparatus, a first message,
wherein the first message includes first information indicating that the apparatus is capable for a Network Slice Admission Control (NSAC) and second information indicating that the apparatus interacted with a Network Slice Admission Control Function (NSACF) apparatus for the NSAC; and
means for retaining a second message for the NSAC to be sent to the NSACF in a case where the apparatus sends the first message to the AMF apparatus.

supplementary note 20. An apparatus related to Session Management Function (SMF) comprising:
means for sending, to an Access and Mobility Management Function (AMF) apparatus, a first message; and
means for sending, to a Network Slice Admission Control Function (NSACF) apparatus, a second message for a Network Slice Admission Control (NSAC) in a case where the first message does not include first information indicating that a second apparatus related to SMF is capable for the NSAC and second information related to interaction between the second apparatus and the NSACF apparatus for the NSAC.

supplementary note 21. A method of a first apparatus comprising:
communicating with a second apparatus; and
receiving, from the second apparatus, a first parameter related to Network Slice Admission Control (NSAC) status, wherein the second apparatus sends, to a third apparatus, a second parameter to increment the number of Protocol Data Unit (PDU) session(s) based on the first parameter.

supplementary note 22. A method of a second apparatus comprising:
sending, to a first apparatus, a first parameter related to
Network Slice Admission Control (NSAC) status; and increasing number of the communication apparatus being registered for a network slice parameter in a case where the first parameter does not include information indicating that the second apparatus communicate with a third apparatus regarding the number of the communication apparatus.

supplementary note 23. A method of a first apparatus comprising:
sending, to a second apparatus, a third parameter related to Network Slice Admission Control (NSAC) status; and
sending, to forth apparatus, a message to decrement number of Protocol Date Unite (PDU) session (s) based on the third parameter.

supplementary note 24. A method of a first apparatus comprising:
receiving, from a second apparatus, a third parameter related to Network Slice Admission Control (NSAC) status; and
sending, to a third apparatus, a fourth parameter to decrement number of communication apparatus being registered for a network slice parameter based on the third parameter.

supplementary note 25. The method according to supplementary note 21, supplementary note 22, supplementary note 23 or supplementary note 24, wherein the first apparatus is Access and Mobility Management Function (AMF).

supplementary note 26. The method according to supplementary note 21, supplementary note 22, supplementary note 23 or supplementary note 24, wherein the second apparatus includes Session and Management Function (SMF) and PGW-C.

supplementary note 27. The method according to supplementary note 21, supplementary note 22, supplementary note 24, wherein the third apparatus is Network Slice Admission Control Function (NSACF).

supplementary note 28. The method according to supplementary note 22 or supplementary note 24, wherein the communication apparatus is User Equipment (UE).

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111028663, filed on Jun. 25, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
77 NSACF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
751 transceiver circuit
752 network interface
753 controller
754 memory
771 transceiver circuit
772 network interface
773 controller
774 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7541 operating system
7542 communications control module
7741 operating system
7742 communications control module
60521 transceiver control module
61421 transceiver control module
62421 transceiver control module
70421 transceiver control module
71421 transceiver control module
75421 transceiver control module
77421 transceiver control module

What is claimed is:

1. A method for a Network Slice Admission Control Function (NSACF) comprising:
receiving, from a core network node for session management control and Packet data network Gateway (PGW) Control plane control, a request message to count the number of Protocol Data Unit (PDU) session for a network slice; and
not counting the number of the PDU session for the network slice in a case where a User Equipment (UE) with ongoing Protocol Data Network (PDN) connection moves from Evolved Packet Core network (EPC) to 5G Core Network (5GC).

2. The method according to claim 1, wherein the counting is to increase or decrease the number of the PDU session for the network slice.

3. The method according to claim 1, wherein the core network node for session management control and Packet data network Gateway (PGW) Control plane control is a SMF+PGW-C.

4. The method according to claim 1, wherein the moving from the EPC to 5GC is a handover from the EPC to the 5GC.

5. A Network Slice Admission Control Function (NSACF) comprising:
a memory; and
at least one processor configured to access the memory and configured to:
receive, from a core network node for session management control and Packet data network Gateway (PGW) Control plane control, a request message to count the number of Protocol Data Unit (PDU) session for a network slice; and
not count the number of the PDU session for the network slice in a case where a User Equipment (UE) with ongoinq Protocol Data Network (PDN) connection moves from Evolved Packet Core network (EPC) to 5G Core Network (5GC).

6. The NSACF according to claim 5, wherein the counting is to increase or decrease the number of the PDU session for the network slice.

7. The NSACF according to claim 5, wherein the core network node for session management control and Packet data network Gateway (PGW) Control plane control is a SMF+PGW-C.

8. The NSACF according to claim 5, wherein the moving from the EPC to 5GC is a handover from the EPC to the 5GC.

9-28. (canceled)
